(19) United States
(12) Patent Application Publication
(10) Pub. No.: US 2026/0248598 A1
(43) Pub. Date: Aug. 27, 2026

(54) CONNECTOR SYSTEM FOR A DENTAL IMPLANT

(71) Applicants: MAXON INTERNATIONAL AG, Sachseln (CH); INSTITUT STRAUMANN AG, Basel (CH)

(72) Inventors: Thorsten BUURLAGE, Gorxheimertal (DE); Jochen KULLICK, Offenburg (DE); Bernd GADDUM, Baden-Baden (DE); Frank FIX, Remchingen (DE)

(21) Appl. No.: 18/874,910

(22) PCT Filed: Jun. 13, 2023
(86) PCT No.: PCT/IB2023/056099

§ 371 Date: Dec. 13, 2024

(30) Foreign Application Priority Data
Jun. 13, 2022 (EP) 22178786.4
Feb. 13, 2023 (EP) 23156213.3

(51) Int. Cl. A61C 8/00

(52) U.S. Cl. CPC A61C 8/0068; A61C 8/006; A61C 8/0069

(57) ABSTRACT

A coupling part for connecting a base of a dental implant to an abutment of the dental implant has a main body, an elongated hole along a longitudinal axis of the main body, at least one snap-in element which is suitable for engaging in a snap-in operational connection with at least one counter-snap-in element of a connection part that can be arranged in the elongated hole and a contact portion for sealingly contacting the coupling part with the base.

### TECHNICAL FIELD

The invention relates to a coupling part for a modular dental implant, an assembly for a modular dental implant, a kit for such an assembly, a modular dental implant, and a kit for such a modular dental implant.

### BACKGROUND

Dental implants can be configured as one-piece or multi-piece devices. In general, multi-piece dental implants have established themselves due to their advantages over single-piece dental implants. Multi-piece dental implants can be better adapted to the specific intended use due to their modularity. They also allow the definitive implant to be built up sequentially, so that undesirable stress during the healing process can be avoided, for example.

The multi-piece dental implants known from the prior art generally comprise a base to be inserted into a jawbone, an abutment to be attached to the base and a superstructure to be placed on the abutment. The base and abutment are connected by a connection part.

The connection part is often configured as a threaded bolt which, when screwed into an internal thread of the base, positively connects the abutment and the base. The threaded bolt can have engagement means for turning the threaded bolt at a coronal end facing away from the thread. A head piece with a larger diameter is used to positively secure the abutment. This can be molded onto the bolt. Alternatively, the connection part can have a modular structure comprising a threaded bolt to be screwed into the base and a head piece that can be mounted on the coronal end, as disclosed by way of example in US 2008/0233538 A1.

Connection parts that are expanded in the base in order to achieve a form-fit connection are also known. Such a dental implant is disclosed, for example, in US 2013/0224689 A1.

The base, also known as the implant body, is intended to functionally replace the tooth root and is usually cylindrical or conical in shape. The base usually has a thread that can be used to screw the base into the jawbone.

The abutment, also called implant abutment, serves as an intermediate link between the base and the superstructure and is usually connected to the base with a positive fit, e.g. screwed and/or glued.

The superstructure is the actual dental prosthesis, in the form of a crown or bridge, or even a denture. It is also possible to design the abutment and superstructure as a one-piece element, for example as a one-piece crown. A dental implant can also have two or more bases for anchoring a superstructure, for example in the case of bridges and dentures. In the latter case, so-called locators can be used as abutments, to which the corresponding attachment points of a denture are positively and non-positively attached.

In dental prosthetics, biocompatible and/or bioinert materials are preferably used. Titanium or titanium alloys are frequently used due to their biocompatibility, as well as ceramic materials such as zirconium oxide ceramics. Both the material and the structure of the base should enable a high degree of osseointegration and periointegration. The aforementioned requirements regarding high biocompatibility and bio inertness also apply to the abutment and the superstructure. Furthermore, the forces occurring in the dentition place high mechanical demands on the material and design. Dental implants must be able to absorb the high forces that occur during use of the dentition without breaking, cracking or loosening.

Titanium has the advantage of being tough and not brittle. However, one disadvantage of titanium is that it can be perceived as a foreign body in the oral cavity due to its dark grey color. Titanium is therefore preferred for those parts of a dental implant that are not visible in the oral cavity, for example because they are embedded in the jaw or covered by gums, or because they are located within the dental implant or the superstructure. As a rule, the base is embedded in the jaw. The abutment may be covered by the gum and/or the superstructure.

Ceramic materials such as zirconium oxide have the advantage over titanium that the coloring essentially corresponds to the natural coloring of teeth, so that the corresponding parts of a dental implant are not perceived as foreign bodies. Ceramic parts are preferably used for tooth abutments and other parts visible in the oral cavity.

An inadequate connection between the abutment and the base can lead to loosening or damage to the dental implant. For the long-term success of a dental implant, it is also important that the inside of a dental implant is well and permanently sealed against the outside. Leaky connections allow bacteria to penetrate the implant, which can lead to peri-implantitis and cause jawbone atrophy.

The modular design of dental implants can mean that the individual parts, especially if they are made of comparatively brittle ceramic material, are mechanically less stable than one-piece implants, particularly in relation to shear forces transverse to the implant axis.

The assembly of modular implants can be difficult, especially in the narrow oral cavity area, because two or more elements have to be placed at the same time.

US 2019/0223986 A1 discloses a modular dental implant comprising a base and an abutment, which are connected by a screw-like connection part. The dental implant additionally has a cylindrical socket, which is provided with at least one snap-in element. The snap-in element is configured such that it can engage in a counter-snap-in element formed on the connection part, in order to connect the bushing body and the connection part, and thus also a body that is fixed in a form-fitting manner between the bushing body and the connection part, to one another in a manner that is at least temporarily captive. In the assembled state of the dental implant, the cylindrical socket lies inside the implant and reinforces the dental implant in an upper area against shear forces transverse to the longitudinal axis.

In most cases, the base and the abutment are configured as two separate components. This has the advantage that the base and the abutment can be adapted to individual requirements. Another advantage is that the abutment can be made of a different material than the base.

A connecting piece, also known as an adapter or coupling piece, can be used to connect the base and the abutment.

EP1269932 discloses a ceramic post and a metallic connecting piece positively connected thereto, which can be attached to an implant by means of a screw. The screw passes centrally through the post and the connecting piece and is supported by its head on an inner shoulder of the post. There is a form-fit anti-rotation lock between the post and the connecting piece, effective on both sides of a plane passing through the screw axis.

U.S. Pat No. 5,685,714 discloses a support post for use with a dental implant which can support a dental prosthesis. The support post includes an area which is in contact with the dental implant when mounted. An intermediate member is attached to the post at least at a junction between the post and the implant. The intermediate element and the support post have different material properties.

There is a general need for improvements in this area.

### DESCRIPTION OF THE INVENTION

One task of the invention is to provide a modular dental implant system which allows a more flexible structure of the individual components, in particular in order to be able to easily adapt the dental implant to the specific conditions of the intended use.

Dental implants according to the invention should be safe and reliable in use. They should also be inexpensive to manufacture.

The invention is further based on the consideration that, when providing a patient with a dental implant, the choice between different prosthetic abutments in a wide variety of materials for attachment to a base is advantageous. Furthermore, the manipulation of the selected abutment when it is combined with a suitable base should remain manageable, in particular with regard to a possible loss of the abutment in the oral cavity of a patient.

Thus, it is a further task of the invention to provide a coupling part and an assembly comprising the coupling part, wherein the coupling part is configured as an interface. The coupling part is intended to allow the attachment of different prosthetic abutments made of different materials, preferably ceramic, to a base. Furthermore, the coupling part and the components of the assembly should allow easy and safe manipulation.

According to the present invention, these objectives are achieved by the elements of the independent claims. Further advantageous embodiments also emerge from the dependent claims and the description. The solution according to the invention can be further improved by various embodiments, each of which is advantageous in its own right and, unless otherwise stated, can be combined with one another as desired.

These embodiments and the advantages associated with them are discussed below.

A first aspect of the invention relates to a coupling part for connecting a base of a dental implant to an abutment of the dental implant.

Such a coupling part according to the invention has a main body, an elongated hole along a longitudinal axis of the main body, at least one snap-in element which is suitable for engaging in a snap-in operational connection with at least one counter-snap-in element of a connection part that can be arranged in the elongated hole, a contact portion for sealingly contacting the coupling part with the base.

The coupling part can be used to provide a standardized connection between any base of a dental implant and any abutment of the dental implant. The abutment can, for example, comprise a superstructure or the supra construction, a dental crown, a denture, a locator, an abutment or a healing component such as a gingiva former. The abutment and the base can be connected to each other using a connection part, e.g. a screw. To connect the parts, the connector or the connection part can be guided through the abutment and then through the elongated hole of the coupling part. When the dental implant is assembled, the connector is also connected to the base and thus connects the abutment and the coupling part to the base.

The connector can be guided through the elongated hole of the coupling part until the at least one snap-in element of the coupling part engages with the at least one counter-snap-in element of the connector, so that the connector and the coupling part are at least temporarily connected to each other. The coupling part, the connector and the abutment are held together by the engaged active connection. This facilitates installation and increases safety when installing the parts in the oral cavity. Especially if the parts are to be installed in the area of the lower jawbone, as otherwise the coupling part can simply slip off the connector due to gravity.

A tight fit of the coupling part on the base ensures a permanently tight seal between the interior of a fully assembled dental implant and the exterior, thus preventing germs from entering the implant. Likewise, no foreign substances, such as abrasion, can get from the dental implant into the outer space and thus into the body of the implant wearer.

In an advantageous embodiment, the coupling part rests on the outer circumference of the contact portion on the base. An apical sealing surface of the contact portion is thus arranged radially as far away as possible from the longitudinal axis. The fact that the apical sealing surface is arranged in an outer area of the contact portion facing the oral cavity prevents impurities and germs from getting between the coupling part and the base and settling there. This is advantageous for hygienic reasons.

In an advantageous embodiment of a coupling part according to the invention, the contact portion on the base of the coupling part is configured as a flat surface perpendicular to the longitudinal axis of the base.

The surface lying perpendicular to the longitudinal axis can transfer compressive forces caused by chewing with the dental implant well from the abutment and the coupling part to the base. With a larger or two-stage flat surface, the contact point can be located as far away as possible from the longitudinal axis, towards the oral cavity. This prevents bacteria and food debris from entering the implant or parts of the implant.

In another advantageous embodiment of a coupling part according to the invention, the contact portion on the base of the coupling part is configured as the lateral surface of a straight truncated cone aligned with the longitudinal axis.

In a further advantageous embodiment of a coupling part according to the invention, the contact portion on the base of the coupling part is configured as the lateral surface of a curved truncated cone aligned with the longitudinal axis.

The conical or curved-conical lateral surface of the contact portion of the base of such a coupling part is intended to be accommodated in a correspondingly shaped straight conical or curved-conical receptacle of a base. The conical outer surface and the conical receptacle are dimensioned in such a way that when the coupling part and the base are braced along the longitudinal axis, the two conical outer surfaces are supported. The support can be a flat or ring-shaped support. The coupling part is fixed radially in the base. The support creates a bacteria-proof transition between the coupling part and the base.

In yet another advantageous embodiment of a coupling part according to the invention, the contact portion on the base of the coupling part is configured as the lateral surface of a conical depression in the base that is aligned with the longitudinal axis. The conical recess can in turn have the shape of a straight cone or a curved cone.

The conical or curved-conical lateral surface of the contact portion of the base of such a coupling part is configured to accommodate a correspondingly shaped straight truncated cone or curved truncated cone of a base. The conical outer surface and the conical receptacle are dimensioned in such a way that when the coupling part and the base are braced along the longitudinal axis, the two conical outer surfaces are supported flat. The coupling part is radially fixed in the base.

Advantageously, in a coupling part according to the invention, a contact portion in the form of a flat surface is arranged at an apical longitudinal end of the coupling part. As a result, forces that occur during chewing with the implant are transferred directly vertically into the base.

It is also advantageous for the contact portion to be as far away as possible from the longitudinal axis of the dental implant. The contact portion should be close to the outside of the implant, towards the oral cavity. This prevents the penetration of bacteria and food debris into the implant or parts of the implant.

The coupling part according to the invention forms the interface between the base and the abutment of a dental implant. This has the advantage that no direct interface between the base and the abutment is necessary, but instead the coupling part according to the invention provides the appropriate interface to the base or to the abutment. For example, it is possible to provide bases with two different outer diameters whose conical receptacles have different dimensions. Accordingly, two coupling parts with matching interfaces, i.e. correspondingly dimensioned contact portions, must be provided. The interface between the coupling part and the abutment, although there are usually different types of abutment, can always be the same regardless of the abutment. This means that different abutments with different interfaces for different sizes of base elements do not have to be stored and provided, or the number of possible combinations is increased. Furthermore, coupling parts according to the invention make it possible to combine bases and abutments from different manufacturers and thus provide the best possible implant for the specific needs of a patient.

Furthermore, the connection between the coupling part and the abutment can be made free of adhesive and assembly or disassembly remains possible at any time.

The main body of a coupling part according to the invention can be essentially rotationally symmetrical. This is particularly advantageous in the case of ablative manufacturing, as the shaping can essentially be carried out by turning.

Furthermore, the base of the dental implant is advantageously essentially rotationally symmetrical in order to screw it into the jawbone. To ensure that the forces during chewing with the dental implant are transferred as evenly as possible from the abutment via the coupling part into the base, the coupling part and the abutment are also advantageously configured to be essentially rotationally symmetrical. Furthermore, an essentially rotationally symmetrical interface can be produced easily and cost-effectively for the various abutments and base.

Advantageously, in a coupling part according to the invention, the at least one snap-in element is configured as an elastic snap-in element.

The snap-in element allows a coupling part to form a snap-in active connection with the at least one counter-snap-in element of a connection part that can be arranged in the elongated hole. The elasticity of the snap-in element prevents the snap-in element from being damaged or breaking off when the parts are brought together or separated. In addition, the elasticity ensures a good active connection between the parts, preventing them from being separated unintentionally.

Advantageously, the coupling part can be reversibly connected to the connection part. A fully reversible connection can be created using the snap-in elements and the counter-snap-in elements. The connection is made without adhesives, which means that no additives are required that have to meet strict approval requirements. It is also possible to separate the components after joining. Furthermore, the abutment can be reversibly connected to the coupling part and/or the connection part.

A coupling part according to the invention can additionally comprise at least one further snap-in element which is suitable for entering into a snap-in active connection with at least one further counter-snap-in element of an abutment. This allows the coupling part and the abutment to be additionally connected to one another, for example before the connection part is inserted into the elongated hole.

Advantageously, the at least one further snap-in element is configured as an elastic snap-in element. Here too, the elasticity of the at least one further snap-in element can prevent the snap-in element from being damaged or breaking off when the parts are brought together or separated. In addition, the elasticity can achieve a good effective connection between the parts, preventing them from being separated unintentionally.

Alternatively or additionally, in a coupling part according to the invention, at least one snap-in element can be provided at a coronal longitudinal end and/or at an apical longitudinal end of the base. By arranging the snap-in element at one of the ends of the coupling part, for example, the base can rest against the connection part, while the snap-in elements project beyond it and can be made elastic in the axial direction by the extension.

Advantageously, in a coupling part according to the invention, the at least one snap-in element is configured as a latch hook formed parallel to the longitudinal axis on the base. A latch hook can simply enter into an active snap-in connection with the counter-snap-in element, for example in the form of a snap-in groove. The alignment parallel to the longitudinal axis gives the snap-in element additional elasticity, in particular for a deflection of the snap-in element perpendicular to the longitudinal axis.

Such a snap-in element can then form a latch-snap connection with a corresponding counter-snap-in element of a connection part, for example a corresponding recess.

A particularly advantageous feature of such a coupling part according to the invention is that the latch hook has a spring-elastic lever arm aligned parallel to the longitudinal axis.

At the end of the lever arm, a snap-in lug aligned with the longitudinal axis is arranged even more advantageously in such an embodiment.

In a further advantageous embodiment, the snap-in lug comprises a snap-in lug extending obliquely to the longitudinal axis of the coupling part in the direction of the elongated hole. The inclined snap-in lug may extend from the distal end of the lever arm if the snap-in element comprises the lever arm and the snap-in lug. Alternatively, the snap-in lugs can also extend from another component of the coupling part if the snap-in element consists entirely of the snap-in lugs.

When the snap-in element and counter-snap-in element are connected, the elastic spring arm is temporarily deflected radially until the snap-in lug snaps into a corresponding recess in the counter-snap-in element.

In a preferred embodiment, the end of the at least one snap-in lug facing the connection part has a convex curvature relative to a longitudinal axis of the connection part, the radius of curvature of which corresponds to the radius of the connection part. This results in a contact zone, concentric to the longitudinal axis of the connection part, between the snap-in lug and the connection part during engagement or disengagement, which keeps the connection part centered in the assembled state.

In a preferred embodiment, the end of the at least one snap-in lug facing the connection part has a rounded edge to enable easy snap-in or unsnap-in.

In a preferred embodiment, the coupling part comprises a plurality of snap-in elements, which enable better retention on the connection part. In a particularly preferred embodiment, the plurality of snap-in elements are spaced equally far apart in the circumferential direction in order to hold the connection part symmetrically. Three snap-in elements form an embodiment that allows axial retention on the connection part so that the connection part remains centered around the longitudinal axis of the coupling part. The number of snap-in elements can be selected in order to achieve a predetermined force when holding the connection part. For example, six snap-in elements can be provided to ensure a tight and secure axial retention of the connection part.

Furthermore, the plurality of snap-in elements can have the same design to enable simple manufacture.

In a preferred embodiment, the plurality of snap-in lugs are configured in such a way that they remain in contact with the connection part, in particular with a wall surface of the counter-snap-in element, in the assembled state. In this way, the connection part can be held centered around the longitudinal axis of the coupling part and, if necessary, a relative position of the components of the assembly can be maintained.

In a preferred embodiment, the end of the snap-in lugs facing the connection part lies in a snap-in lug plane that runs perpendicular to the longitudinal axis of the coupling part. This ensures a symmetrical distribution of the spring forces of the snap-in lugs acting on the connection part. In the assembled state, an axial movement of the snap-in lugs engaged in the counter-snap-in element from a first axial position of the snap-in lug plane to a second axial position of the snap-in lug plane can also be configured. This axial movement allows axial play of the coupling part relative to the connection part and thus to the abutment.

Furthermore, in a coupling part according to the invention, at least one guide element is advantageously provided at a coronal longitudinal end of the base, which is suitable for aligning the coupling part relative to an abutment of a dental implant with respect to the longitudinal axis.

This ensures correct alignment of the body section and coupling section to each other.

In a particularly advantageous embodiment of such a coupling part according to the invention, the at least one guide element is formed by a cylindrical projection projecting from the coronal longitudinal end of the base and aligned with the longitudinal axis. The cylindrical projection can be continuous or interrupted.

In such an embodiment, the at least one snap-in element can protrude coronally from the guide element. In a preferred embodiment of this type, the snap-in element comprises a snap-in lug extending from the guide element at an angle to the longitudinal axis of the coupling part in a coronal direction. The snap-in lug can be arranged directly on the guide element or on an axially extending lever arm.

In a preferred embodiment, the guide element is interrupted by a plurality of guide segments. If the guide element is formed by guide segments, the guide segments can form an imaginary hollow cylindrical guide element. Guide segments, which are each formed by an interruption in the circumferential direction of the guide element and carry a snap-in lug, can advantageously be taken into account in the design of the snap-in lug, in particular its spring effect.

In a preferred embodiment, the guide element, possibly the guide element formed interrupted by a plurality of guide segments, has a radially inner wall surface which, viewed in the radial direction, is offset radially outwards towards the wall surface of the elongated hole of the coupling part. The radially inner wall surface of the guide element thus delimits a circumferential inner space above the elongated hole, which inner space is intended to accommodate a preferably circumferential thickening of the connection part when the at least one snap-in lug is engaged in the counter-snap-in element. The thickening can have the shape of a bead.

In a preferred embodiment, the coupling part comprises a plurality of guide segments and a plurality of snap-in elements, each of which can protrude from a guide segment. Guide segments that are equally spaced apart in the circumferential direction and have the same design are particularly preferred in order to enable simple manufacture.

In further embodiments, the snap-in elements are arranged independently of the guide elements.

Alternatively, the at least one guide element can be configured as a circular recess arranged at the coronal longitudinal end of the base and aligned in line with the longitudinal axis.

The guide elements are used to align the superstructure part and the coupling part to each other during connection and to guide them during assembly so that they do not tilt.

These aforementioned guide elements can also transmit radial shear forces between the superstructure part and the coupling part.

In an advantageous embodiment, a rotary undercut is formed at the coronal longitudinal end of the coupling part in the area of the guide element.

The rotary undercut can be arranged at the base of the guide element. The rotary undercut prevents a radial or right-angled transition at the level of the coronal sealing surface at the transition to the guide element. This ensures a good bacteria-tight seal between the two components, as no radial transition between the guide element and the coronal sealing surface of the coupling part can hinder the sealing contact of the apical sealing surface of the abutment. Avoiding a right-angled transition also reduces the risk of cracking. The rotary undercut also means that the coronal sealing surface can be completely machined, for example with a grinding wheel.

Furthermore, in an advantageous coupling part, a transition section can be connected to a contact portion of the base configured in the form of a straight-conical lateral surface or curved-conical lateral surface.

Advantageously, the outer radius of the coupling part at the coronal end of the transition section is identical to the outer radius of the abutting abutment of the dental implant, so that no protruding edges are created in this transition area of the dental implant.

Such a transition section is not arranged in the conical receptacle of the base and there-fore does not have to be conical. Nevertheless, it is particularly advantageous that the angle of inclination of the lateral surface of the coupling part at the coronal end of the transition section is identical to the adjoining lateral surface of a superstructure part, so that a smooth lateral surface results with identical outer radii.

Advantageously, the surface of the coupling part and/or the surface of the base in the contact portion or in a contact area have a geometric continuity G1 (tangential continuity).

A G1 continuity of the surfaces in the contact portion means in particular that there are no edges (continuity G0) on any of the surfaces in the contact area that can hook into the opposite surface and shear off material if the components are displaced relative to each other, even slightly, or can themselves be sheared off particularly easily.

It is particularly advantageous for the surface of the coupling part and/or the surface of the base to have a geometric continuity G2 (curvature continuity) in the contact portion or in the contact area.

The advantage of such G2 continuity of the surfaces in the contact portion is that the contact pressure remains approximately constant with a small relative displacement of the components in relation to each other. The uniformly acting forces lead to a reduced asymmetrical mechanical force effect.

Advantageously, the coupling part comprises a coronal sealing surface for tight contact between the abutment and the coupling part. The coronal sealing surface prevents the penetration of impurities and germs such as bacteria into the implant. Due to the tight support, forces that act on the abutment during chewing can also be transferred well to the coupling part. A wider support reduces the contact pressure and there is less tension in the parts. The contact pressure can be increased with a narrow support, so that a good seal is created between the parts. The coronal sealing surface can form a second contact portion of the coupling part.

In a further advantageous embodiment, a coronal sealing surface is provided at a coronal longitudinal end of the base and is configured as a flat, annular surface perpendicular to the longitudinal axis of the base.

Advantageously, in a coupling part according to the invention, a flat, annular coronal sealing surface perpendicular to the longitudinal axis of the base is provided at a coronal longitudinal end of the base.

Such a sealing surface lies in a normal plane of the longitudinal axis. An abutment advantageously has an analogous sealing surface at an apical longitudinal end, so that when the dental implant is assembled, the two sealing surfaces mentioned overlap flush and thus seal the interior of the dental implant from the exterior.

Alternatively, the sealing surfaces can also be configured as conical lateral surfaces, but this makes the production of the parts more complex.

In an advantageous embodiment, the coronal sealing surface is arranged on the outer circumference of the contact portion between the abutment and the coupling part. The coronal sealing surface is thus arranged radially as far away as possible from the longitudinal axis. The fact that the coronal sealing surface is arranged in an outer area of the contact portion facing the oral cavity prevents impurities and germs from getting between the abutment and the coupling part and settling there. This is advantageous for hygienic reasons.

In a further advantageous embodiment of a coupling part according to the invention, a rotation-locking section with a non-rotationally symmetrical outer contour is provided at a coronal longitudinal end and/or at an apical longitudinal end of the base. The anti-rotation section can also have a rotationally symmetrical outer contour. A rotationally symmetrical anti-rotation section can, for example, be n-fold rotationally symmetrical, e.g. polygonal or oval.

Such an anti-rotation element or anti-rotation section can, for example, be configured as a section of the base adjoining the conical contact portion, which has a quadrangular or hexagonal cross-section or n-cornered cross-section instead of a round cross-section. Together with an oppositely shaped receptacle in the base or in the superstructure part, this results in positive locking of the corresponding components against rotation about the longitudinal axis. This is particularly advantageous in order to prevent the surfaces of the components of a dental implant according to the invention resting on each other from sliding over each other when a connection part is screwed in, so that abrasion and mechanical damage to the surfaces are avoided.

In a further advantageous embodiment of a coupling part according to the invention, the anti-rotation section is configured without rotational symmetry about the longitudinal axis. For example, an asymmetry in the outer contour can be provided at one point, so that the superstructure part and the coupling part or the coupling part and the base can only be mounted in a single, correct alignment to one another. Such a rotation locking section without rotational symmetry is called an indexing section. Such an indexing section, when mounted, can cooperate with a complementary structure of the abutment or the base to allow a single position of the abutment or the base relative to the coupling part. The indexing portion is free of axes about which rotations about an angle map the indexing portion onto itself. In other words, the indexing section has no rotational symmetry about the longitudinal axis of the coupling part.

In a preferred embodiment, if the coupling part has a guide element, the guide element can form the rotation-locking section, wherein the guide element can have a non-rotationally symmetrical outer contour or an n-fold rotationally symmetrical outer contour.

In a particularly advantageous embodiment of such a coupling part according to the invention, the guide element is formed protruding at the coronal longitudinal end of the base and aligned with the longitudinal axis. The guide element has a non-rotationally symmetrical or n-fold rotationally symmetrical outer contour in order to fix the rotational alignment of the coupling part to the abutment. In a preferred embodiment, the guide element extends along the longitudinal axis of the coupling part in the shape of a prism. For example, the guide element has a square or hexagonal polygonal outer contour. Alternatively, the guide element can comprise an indexing section.

In a preferred embodiment, the indexing section is formed by at least one flattening of the radially outer wall surface of the guide element, with the flattening running in a plane parallel to the longitudinal axis of the coupling part. The geometry of the guide element is therefore configured in such a way that the abutment can only be placed on the coupling part in a defined position. For this purpose, the abutment has a corresponding complementary structure, i.e. the wall surface of the receiving opening can be cylindrical and accordingly has at least one flattening in a plane running parallel to the longitudinal axis of the coupling part. In the assembled state, both flats can be brought into engagement. The positive fit simultaneously creates a rotation-proof connection.

In another preferred embodiment, the radially outer wall surface of the guide element has at least one radially extending cam which can be brought into engagement with a groove in the wall surface of the receiving opening in the assembled state, thereby producing an indexing section. A rotation-secured connection between the coupling part and the abutment is also produced by positive locking.

In a preferred embodiment, the radially outer wall surface of the guide element has a profile which, when assembled, is intended to interact with a further complementary structure of the abutment in order to form an anti-rotation lock between the abutment relative to the coupling part. In this respect, structures similar to those used for the indexing section can be used, whereby the structures can be rotationally symmetrical.

In embodiments in which the guide element forms the anti-rotation section, the at least one snap-in element preferably extends in a coronal direction from the guide element.

In an advantageous embodiment, the apical sealing surface of the abutment rests on the coronal sealing surface of the coupling part in the assembled state, so that the dental implant is sealed at this contact point of the two components. When the dental implant is assembled, this prevents bacteria and impurities from entering the interior of the dental implant.

In a further advantageous embodiment, the apical sealing surface of the coupling part rests on the coronal sealing surface of the base in the assembled state, so that the dental implant is sealed at this contact point of the two components. When the dental implant is assembled, this also prevents bacteria and impurities from entering the interior of the dental implant.

A coupling part according to the invention can be made from a metal, in particular titanium, from a metal alloy, in particular a titanium alloy, from a ceramic material, in particular zirconium oxide, from a polymer material or from a composite material.

Elastic yet stable materials are advantageous if the snap-in element is elastically deformable. However, it is also possible to manufacture a coupling part according to the invention from two different materials. For example, a first element, which carries the elastic snap-in elements, can be made of metal and joined together with a second part made of less elastic ceramic material to form a coupling element.

Advantageously, a coupling part according to the invention is produced by a powder injection molding process.

In general, powder injection molding can be used to produce ceramic or metal parts, for example.

A coupling part manufactured using the powder injection molding process has the advantage that it can also be configured to be non-rotationally symmetrical without making production more complex, as would be the case with subtractive machining processes. The coupling part can be formed by injection molding in a single work step. A subtractive machining process, in particular machining processes such as milling, turning or drilling, which stresses the structure of the component, is no longer necessary. The injection molding process also gives the surface of the component a much better structure than a machined component. If necessary, coupling parts manufactured using the injection molding process can also be additionally finished, for example by vibratory grinding or polishing. It is also easier to produce non-rotationally symmetrical shapes, for example, which would otherwise be more complex to manufacture, for example as milled parts.

Production using powder injection molding can be recognized on a component in particular by the surface of the component. The surface of the component is defined by the smooth surfaces of the injection molds and there are no traces of subtractive machining processes. This reduces the risk of cracking or the colonization of bacteria.

According to conventional dental terminology, “apical” refers to the direction towards the root tip and therefore the jawbone, and “coronal” refers to the direction towards the crown of the tooth.

A second aspect of the invention relates to an assembly for a modular dental implant.

Such an assembly according to the invention, also referred to as a set, comprises an abutment, a connection part for positively connecting the abutment to a base intended for implantation in the bone tissue of a patient, and a coupling part according to the invention as explained above. The abutment, the connection part and the coupling part are aligned along a common longitudinal axis. The connection part can be arranged in an elongated hole of the coupling part and an elongated hole of the abutment. The coupling part, the connection part and the abutment can be connected or joined together in a form-fit manner.

The abutment can comprise, for example, a superstructure, a dental crown, a denture, a locator, an abutment, or a healing component.

The at least temporary positive connection of the abutment, the connection part and the coupling part according to the invention in an assembly according to the invention has the advantage that the assembly can be handled as an integrated part during assembly of the dental implant. The assembly or the connection part of the assembly can thus, for example, be simply placed in the patient's mouth in the bore of the base already implanted in the jawbone when assembling the dental implant, in order to then connect the connecting element to the base in a form-fitting manner and to brace it with respect to the latter, as a result of which all components are finally connected in a form-fitting manner and to form a stable, finished dental implant.

The advantageous form-fit active connection of the three components is achieved by the fact that the at least one snap-in element of a coupling part according to the invention creates a snap-in connection with at least one corresponding counter-snap-in element of the connection part arranged in the elongated hole of the coupling part. The abutment, in turn, is positively fixed between the coupling part and the connection part.

No tools are required to create the active connection. It is sufficient to simply plug the components together in a certain way. As the active connection only holds the three components together during assembly and does not have to absorb any relevant forces, the snap-in connection is mechanically sufficiently stable. Depending on the design of the active connection, the snap-in connection can also be released again without tools.

The abutment can already be connected to a superstructure or can form a one-piece element with the superstructure.

Advantageously, in such an assembly according to the invention, the coupling part can be positively connected or connected to the connection part via a latch-snap connection or a snap-in active connection comprising at least one snap-in element and a counter-snap-in element.

Various types of latch-snap connections or snap-in active connections are known. Snap connections with elastically deformable lever arms are advantageous for the small sizes of dental implants, as they can be easily attached to the parts by design. In addition, a latch-snap connection can easily be brought into operational connection by axial displacement of the connector relative to the coupling part without the need for rotation in the circumferential direction, as is the case with a thread or bayonet lock, for example. A latch-snap connection is sufficient for such connections, as only low forces act between the components during pre-assembly.

In an advantageous variant of such an assembly according to the invention, the coupling part can be positively connected or connected to the abutment via a further latch-snap connection comprising at least one further snap-in element and a further counter-snap-in element.

Such an embodiment has the advantage that when assembling the assembly according to the invention, the coupling part can already be connected to the abutment before the connection part is mounted to the coupling part. Furthermore, it is also possible to provide the coupling part and abutment already pre-assembled in this way.

Advantageously, the connection part of an assembly according to the invention has at least one counter-snap-in element which is or can be operationally connected to at least one snap-in element of the coupling part. By connecting the at least one snap-in element of the coupling part to the at least one counter-snap-in element on the connection part, a snap-in active connection can be produced between the parts.

A particularly advantageous feature of such an assembly is that the at least one counter-snap-in element of the connection part is configured as a radial recess in a lateral surface of the connection part.

The at least one counter-snap-in element of the connection part of the assembly according to the invention can be configured as a circumferential snap-in groove.

The at least one snap-in element of the coupling part can snap into the connection part through a radial recess or a snap-in groove and creates an active connection between the coupling part and the connection part. If, for example, the connection part comprises a thread for connecting the connection part to the base, the connection part can be rotated about its own longitudinal axis without the active connection between the snap-in element and the connection part being released or interrupted.

In a preferred embodiment, the connection part has a preferably circumferential thickening, which apically limits the counter-engagement element. The formation of a counter-snap-in element is a flexible solution for accommodating the at least one snap-in lug and thus determining the axial position of the connection part relative to the coupling part in which it is held.

The circumferential thickening has the advantage that a notch below the head piece of the connection part is not necessary to form the counter-snap-in element, whereby the notch could represent a weak point of the connection part. This solution is therefore particularly favorable when thin connection parts have to be used.

Alternatively, a preferably circumferential indentation below the head piece of the connection part to form the counter-snap-in element can be an advantageous solution if the connection part has a larger diameter. The indentation can be created, for example, by milling a circumferential area of the connection part below the head piece. Both solutions, the thickening or the notch, prevent the engaged snap-in lugs from moving apically. If the counter-snap-in element is circumferential, the at least one snap-in lug can engage in any rotational position of the connection part, which simplifies assembly of the module.

Further embodiments of an assembly in which the at least one counter-engagement element of the connection part is configured as a radial recess in a lateral surface of the connection part are disclosed below.

In a further advantageous embodiment of an assembly according to the invention, the abutment has at least one further counter-snap-in element, which is in operational connection with at least one further snap-in element of the coupling part.

Advantageously, the at least one further counter-engagement element of the abutment of an assembly according to the invention is configured as a radial recess in the region of an apical longitudinal end of the abutment.

In a particularly advantageous embodiment of an assembly according to the invention, the at least one further counter-snap-in element of the abutment is configured as a circumferential snap-in groove.

In a coupling part according to the invention, the connection part and/or the abutment can be made of a metal, in particular titanium, of a metal alloy, of a ceramic material, in particular zirconium oxide, of a polymer material or of a composite material.

The components, in particular the parts made of ceramic, can be manufactured using a powder injection molding process. However, it is also possible to manufacture metallic parts, for example titanium or titanium alloys, using the injection molding process. The components can be produced more cost-effectively by powder injection molding com-pared to a machining process. It is also easier to produce non-rotationally symmetrical shapes, for example, which would otherwise be costly to produce as milled parts, for example.

In a preferred embodiment, the abutment has an apically arranged receiving opening for receiving the guide element and the at least one snap-in element, whereby the receiving opening can have an axial wall surface that is complementary to the axially extending wall surface of the guide element. The guide element thus enables the centering of the prosthetic abutment via its receiving opening during assembly of the subassembly.

In a preferred embodiment, the abutment has a complementary structure which, when mounted, is intended to interact with the indexing section of the coupling part. The indexing section is free of axes in order to map the indexing section onto itself for the rotations through an angle. In other words, the indexing section has no rotational symmetry about the longitudinal axis of the coupling part. This geometry means that the abutment can only be placed in a defined position.

Preferred embodiments of the indexing section have been described above in connection with corresponding embodiments of the coupling part and can be used for the coupling part and the abutment of the assembly. In a particularly preferred embodiment, the complementary structure of the abutment has at least one flattening which extends in a plane parallel to the longitudinal axis of the coupling part and is intended to cooperate with the at least one flattening of the radially outer wall surface of the guide element.

In a preferred embodiment, the abutment has a further complementary structure which, in the assembled state, is intended to interact with the profile of the radially outer wall surface of the guide element in order to form an anti-rotation lock between the abutment relative to the coupling part. In this respect, the same or similar structures as for the indexing section can be used, whereby the further complementary structures can be rotationally symmetrical.

Furthermore, the abutment has an elongated hole, also known as a through hole, for receiving the connection part, whereby the elongated hole has a counter bearing for receiving the head piece of the connection part. In the assembled state, the connection part is inserted into the elongated hole of the abutment and into the elongated hole of the coupling part. In the assembled state, the head piece is supported against the counter bearing. Furthermore, in the assembled state, the at least one snap-in lug or the snap-in element is engaged in the counter-snap-in element of the connection part.

In a preferred embodiment, a counter support surface of the abutment and the wall surface of the receiving opening of the abutment, viewed in longitudinal section, are free of curvatures that have a radius of less than 0.3 mm. This geometry of the receiving opening to the coupling part is thus configured in such a way that the geometry in the abutment can be produced or adapted using a dental milling machine.

A third aspect of the invention relates to a modular dental implant.

Such a dental implant according to the invention comprises a base for implantation in a bone tissue of a patient as well as an assembly according to the invention as explained above.

The base of a modular dental implant according to the invention is already implanted in the patient's bone tissue at the time the dental implant is fitted. Immediately after implantation of the base, a healing element or a gingiva former is generally used as an abutment. Once the base has healed, the abutment is removed again for a temporary or definitive prosthetic restoration and a new one is fabricated. For this purpose, another abutment is installed; the abutment may, for example, comprise an abutment and/or a superstructure such as a dental crown or a denture.

Advantageously, in a dental implant according to the invention, the base, the abutment, the connection part and the coupling part are arranged in alignment along a longitudinal axis of the dental implant and can be connected or connected to one another in a form-fitting manner by the connection part.

In a dental implant according to the invention, the base can be made from a metal, in particular titanium, from a metal alloy, or from a ceramic material, in particular zirconium oxide. In particular, the base can be manufactured using the powder injection molding process. The advantages of the powder injection molding process have already been mentioned above.

A fourth aspect of the invention relates to a kit for constructing an assembly.

Such an assembly kit according to the invention comprises at least one assembly part, at least one connection part and at least one coupling part according to the invention, as defined above in an assembly according to the invention.

Such a kit allows the flexible assembly and mounting of a subassembly according to the invention for subsequent simple assembly with a base to form a finished dental implant according to the invention.

The abutment can comprise, for example, a superstructure, a dental crown, a denture, a locator, an abutment or a healing component such as a gingiva former.

A fifth aspect of the invention relates to a kit for assembling a modular dental implant.

Such a dental implant kit according to the invention comprises at least one base, at least one abutment, at least one connection part and at least one coupling part according to the invention, as they are defined in a dental implant according to the invention as above.

The abutment can comprise, for example, a superstructure, a dental crown, a denture, a locator, an abutment or a healing component such as a gingiva former.

Further aspects of the present invention are also apparent from the following description.

### BRIEF DESCRIPTION OF THE DRAWINGS

For a better understanding of the present invention, reference is made below to the figures. These merely show examples of embodiments of the object of the invention. Identical or similar reference symbols are used in the figures and the associated description for identical or similarly acting parts.

FIG. 1 schematically shows (a) a possible embodiment of a coupling part according to the invention, and (b) the same coupling part as part of a dental implant according to the invention.

FIG. 2 schematically shows (a) another possible embodiment of a coupling part ac-cording to the invention, and (b) the same coupling part as part of a dental implant according to the invention.

FIG. 3 shows schematically in longitudinal section another embodiment of a coupling part according to the invention as part of an assembly according to the invention.

FIG. 4 shows a further possible embodiment of a coupling part according to the invention as part of a dental implant, with a contact portion of the coupling part in the form of an inverted cone.

FIG. 5 shows a further embodiment of a coupling part according to the invention as part of a dental implant, with a flat surface as the contact portion of the coupling part.

FIG. 6 schematically shows (a) a detachable latch-snap connection, (b) a conditionally detachable latch-snap connection, (c) a non-detachable bayonet connection and (d) a non-detachable latch-snap connection between a connection part and a coupling part according to the invention.

FIG. 7 schematically shows a further embodiment of a coupling part according to the invention as part of a dental implant according to the invention, (a) in profile view, (b) in a longitudinal section through the plane A-A, (c) in perspective view, and (d) as an exploded view.

FIG. 8 schematically shows the connection part from FIG. 7, (a) in profile view, (b) in top view, (c) in a longitudinal section through plane A-A, and (d) in a detailed view of area D.

FIG. 9 shows a schematic view of the abutment from FIG. 7, (a) in profile view and (b) in a longitudinal section through plane A-A.

FIG. 10 schematically shows another possible embodiment of a coupling part according to the invention, installed in an assembly according to the invention, (a) as an exploded view, and (b) in longitudinal section.

FIG. 11 schematically shows the coupling part according to the invention from FIG. 10, (a) in perspective view, (b) in top view, (c) in a longitudinal section along A-A, (d) in a detailed view of area C, (e) in a longitudinal section along B-B, and (f) in a detailed view of area D.

FIG. 12 schematically shows two further embodiments of an assembly for a dental implant according to the invention, (a) with a one-piece unit comprising abutment and crown, and (b) with a one-piece unit comprising abutment and gingiva former.

FIG. 13 shows a longitudinal section through an assembly with a coupling part ac-cording to a first alternative embodiment of the invention.

FIG. 14 shows a perspective view of the coupling part shown in FIG. 13.

FIG. 15 shows a top view of the coupling part as shown in FIG. 14.

FIG. 16 shows a side view of the connection part shown in FIG. 13.

FIG. 17 shows a perspective view of a further embodiment of the coupling part.

### WAYS TO CARRY OUT THE INVENTION

In the following discussion of the figures, when an abutment 4 is mentioned, a corresponding superstructure 6 is also meant as an alternative, unless the two variants are explicitly differentiated.

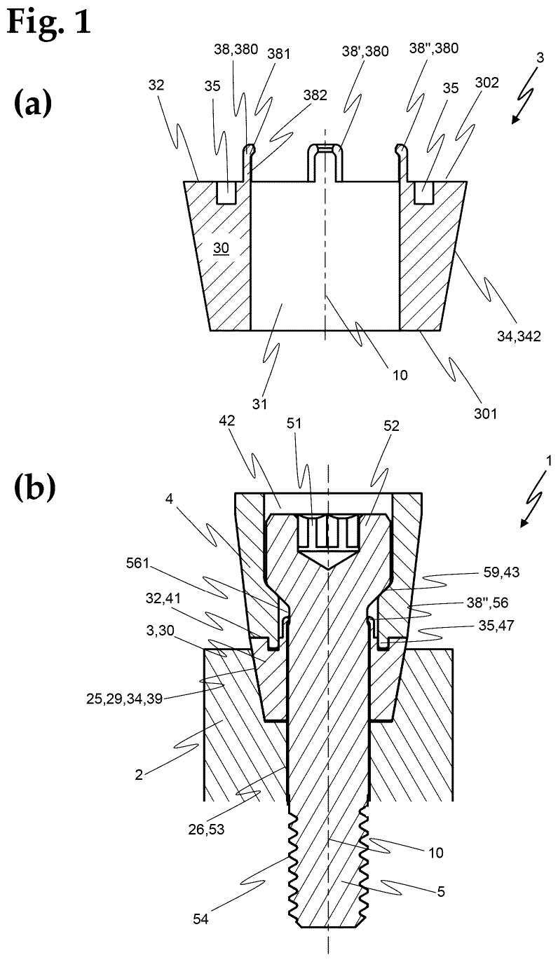

An advantageous embodiment of a coupling part 3 according to the invention, both alone and installed in a dental implant 1 according to the invention, is shown in FIG. 1.

The coupling part 3 comprises a main body 30 in the form of a straight truncated cone, the transverse diameter of which decreases from a coronal longitudinal end 302 of the main body 30 towards an apical longitudinal end 301. An elongated hole 31 runs through the main body 30 along a longitudinal axis 10. The main body 30 is essentially rotationally symmetrical.

A contact portion 34 of the coupling part 3 is provided by the lateral surface 342 of the, for example, straight truncated cone of the base 30. The contact portion 34 is intended to lie flush in the assembled dental implant 1 on the lateral surface of a correspondingly shaped conical receptacle 25 of a base 2, so as to seal off the interior of the dental implant 1 at this contact point 29, 39 of the two parts.

At the coronal longitudinal end 302 of the main body 30, a coronal sealing surface 32 is formed perpendicular to the longitudinal axis 10 in the form of the annular, flat end face. This coronal sealing surface 32 is intended to lie flush against a corresponding flat, apical sealing surface 41 of an abutment 4 (or a superstructure 6) in the assembled dental implant 1 in order to seal the interior of the dental implant 1 at this contact point of the two components.

At the coronal end 302 of the coupling part 30, four snap-in elements are arranged around the opening of the elongated hole 31, which protrude from the base 30 parallel to the longitudinal axis 10. Of the four snap-in elements, three snap-in elements 38, 38′, 38″ are visible. The snap-in elements are configured as latch hooks 380, which comprise a spring-elastic lever arm 382 and a snap-in lug 381 directed radially towards the inside.

On the end face at the coronal longitudinal end 302 of the coupling part 3, a guide element 35 is formed in the form of an annular recess aligned with the longitudinal axis 10. This guide element 35 serves, among other things, to align the abutment in alignment with the longitudinal axis 10 by means of a positive operational snap-in connection with a corresponding guide element 47 of an abutment 4 and thus to facilitate the correct assembly of an assembly according to the invention or of a dental implant according to the invention. Furthermore, the coupling part 3 and the abutment 4 can be supported against each other in the dental implant 1 in the radial direction by this positive connection 35, 47. Radial shear forces that occur during subsequent use of the dental implant can be transmitted directly from the abutment to the coupling part, so that the connection part 5 is only subjected to low radial shear forces.

For the assembly of a dental implant 1 according to the invention, a subassembly 11 according to the invention consisting of a coupling part 3, an abutment 4 and a connection part 5 is created in a first step. In a second step, the assembly is connected to a base 2 already anchored in the patient's jawbone to form the dental implant 1. The assembly can thus be constructed outside the oral cavity and then inserted into the oral cavity as a single component, which greatly simplifies handling. The assembly itself can be built up on site directly before installation. However, the assembly can also be provided already assembled.

To construct the assembly according to the invention, the abutment 4 is placed on the coupling part 3 provided so that an apical sealing surface 41 of the abutment 4 rests on the coronal sealing surface 32 of the coupling part 3. An annularly projecting guide element 47 of the abutment 4 at the apical end is inserted into a guide element 35 configured as an annular groove at the coronal longitudinal end 302 of the coupling part 3. The two guide elements 32, 47 are radially flush in contact, so that a correct alignment of the two components 3, 4 aligned to the longitudinal axis 10 is ensured. A remaining gap is advantageously provided between the apical end face of the guide element 47 and the base of the groove 35 in order to have the axial contact pressure exclusively on the sealing surfaces 32, 41.

Subsequently, the connection part 5, for example in the form of a cylindrical screw, is passed through the elongated hole 42 of the abutment 4 and the adjacent elongated hole 31 of the coupling part 3 from one end of an elongated hole 42 of the abutment 4 facing away from the abutment 3 and aligned with the longitudinal axis. The resilient snap-in elements 38, 38′, 38″, 38′″ are arranged on the coupling part 3, adapted to the dimensions of the connection part 5, in such a way that they are deflected radially outwards by the cylindrical support section 53 of the connection part 5 when passing through the connection part 5. Finally, the snap-in elements 38, 38′, 38″, 38′″ reach a counter-snap-in element 56 of the connection part 5, which is arranged, for example, in the form of a circumferential radial snap-in groove 561 below the head piece 52 of the connection part 5. The snap-in lugs 381, which are spring-loaded by the deflected latch hooks 380, move inwards into the circumferential radial snap-in groove 561, resulting in a positive connection between coupling part 3 and connection part 5. The connection part 5 has a head piece 52, the outer diameter of which is larger than at least parts of the inner diameter of the elongated hole 42 of the abutment 4. Since the abutment 4 is thus positively fixed between the coupling part 3 and the head piece 52 of the connection part 5, the coupling part 3, the abutment 4 and the connection part 5 are thus positively connected to one another.

It is also possible to first guide the connection part 5 from the coronal end of the abutment 4 through the elongated hole 42 of the abutment 4, aligned with the longitudinal axis, and then to guide the connection part 5 from the coronal end of the coupling part 3 through the elongated hole 31 of the coupling part 3, through the elongated hole 31 of the coupling part 3 until the abutment 4 and the coupling part 3 rest against each other and the snap-in elements 38, 38′, 38″, 38′″ connect positively with the counter-snap-in element 56 of the coupling part 5.

Advantageously, the snap-in elements 38, 38′, 38″, 38′″ are configured in such a way that the snap-in lugs 381 engage in the notches of the thread of the apical threaded section of the screw-shaped connection part 5. This means that the thread can be screwed in to pass through the threaded section without the snap-in lugs having to slide over the thread. This avoids unwanted abrasion and possible damage to the components.

Alternatively, the outer diameter of the threaded section of the connection part 5 can also be selected so that it is at most the same size as the free inner diameter of the snap-in elements 38, 38′, 38″, 38′″ defined by the snap-in lugs 381, and advantageously smaller. When passing through the apical thread section, the snap-in elements 38, 38′, 38″, 38′″ are then not deflected or only slightly deflected.

The aforementioned positive connection of the three components 3, 4, 5 of the assembly 11 does not yet have to absorb any external forces. It is therefore not yet necessary to apply force in the longitudinal direction. If necessary, a slight play can or must even remain between the individual components 3, 4, 5. However, for more precise handling of an assembly 11 according to the invention, the spatial positions of the individual components of the assembly in relation to each other are preferably fixed as far as possible.

The design of the counter-snap-in element 56 as a circumferential snap-in groove 561 has the advantage that the rotational alignment of the connection part 5 to the coupling part 3 is not relevant. This in turn makes it easier to handle. It also allows the connection part 5 to rotate freely relative to the coupling part 3 about the longitudinal axis 10, which is advantageous when the connection part 5 is later screwed into the base 2, as the abutment 4 does not rotate with it.

The pre-assembled assembly 11 consisting of coupling part 3, abutment 4 and connection part 5 can now be assembled with the base 2 (of which only the upper, coronal part is shown in the figure), which is already attached in the patient's bone tissue, to form the finished dental implant 1. For this purpose, the apical end of the screw-shaped connection part 5 is inserted into the coronal opening of the blind hole of the base 2 so far that the threaded section of the connection part 5 reaches the internal thread in the hole. Then, using a suitable tool which engages in an engagement means 51 in the head piece 52 of the connection part 5, the external thread of the screw-shaped connection part 5 can be screwed into the internal thread of the bore of the base 2.

If, when screwing in the connecting screw 5, the frustoconical contact portion 34 of the coupling part 3 reaches the conical receptacle 25 of the base 2, the connection part 5 must be screwed in further, despite the now fixed coupling part 3, until the intended tightening torque is reached. To do this, the connection part 5 must still be able to move a certain distance in the longitudinal direction in relation to the coupling part 3. This can be achieved by a correspondingly wide circumferential snap-in groove 561 of the counter-snap-in element 56, which allows the thread of the connection part 5 to be screwed in further with simultaneous rotational decoupling. The snap-in groove 561 should advantageously be so wide that it can accommodate the snap-in lugs 381 and these still have sufficient residual travel in the longitudinal direction in the snap-in groove 561 that a connecting screw can be completely screwed in as connection part 5. Alternatively, the snap-in elements can be radially deflected again after reaching the coronal edge of the snap-in groove 561.

In the final position, a conical contact portion of the head piece 52 of the connection part 5 rests on a corresponding conical support surface 43 in the elongated hole 42 of the abutment 4, the apical sealing surface 41 of the abutment 4 rests on the coronal sealing surface 32 of the coupling part 3, and the conical contact portion 34 of the coupling part 3 in the example shown rests on the lateral surface of the conical receptacle 25 of the base 2. Due to the tensile force exerted on the connection part 5 along the longitudinal axis 10 between the head piece 52 of the connection part 5 and the internal thread (not shown) of the base 2, the abutment 4, coupling part 3 and base 2 are braced against each other. By pressing the conical base 30 in the example shown into the conical receptacle 25 of the base 2, the coupling part 3 is supported in a radially stable manner in relation to the base. Due to the coordinated shape of the contact surfaces of the abutting components and the application of tensile force, the interior of the dental implant 1 is sealed off from the exterior.

The assembly 11 is removed in the reverse order of the above-mentioned assembly steps. If necessary, the adhesive forces to be overcome between the various components are greater than the deflection force of the snap-in elements 38, 38′, 38″, 38′″, so that the connection part 5 can be removed from the dental implant 1 first before the remaining components 3, 4 are removed separately by hand.

Alternatively, when constructing a dental implant 1 according to the invention, it is possible to dispense with the prior creation of an assembly 11 (3, 4, 5). In such a case, the coupling part 3 is first inserted into the corresponding receptacle 25 of the base 2. In a second step, the abutment 4is placed on the coupling part 3. In a third step, the connection part 5 is guided through the corresponding through-holes 42, 31 of the abutment 4 and the coupling part 3 and brought into operational connection with the base.

Instead of a separate counter-snap-in element 56, the thread of the connection part can also serve directly as a counter-snap-in element 56 in the case of a screw-shaped connection part 5. In such a case, when assembling the assembly 11, the apical thread of the connection part 5 is turned onto the snap-in lugs 381 of the snap-in elements, which serve as a mating thread. When the connection part 5 is tightened at the end of the assembly process, during which the coupling part 3 is already fixed in relation to the base 2, the latch hooks 380 are then slightly deflected by the flanks of the threaded notches.

In such an embodiment of an assembly, it is also possible to place the coupling part 3 at any position along the threaded section of the connection part 5.

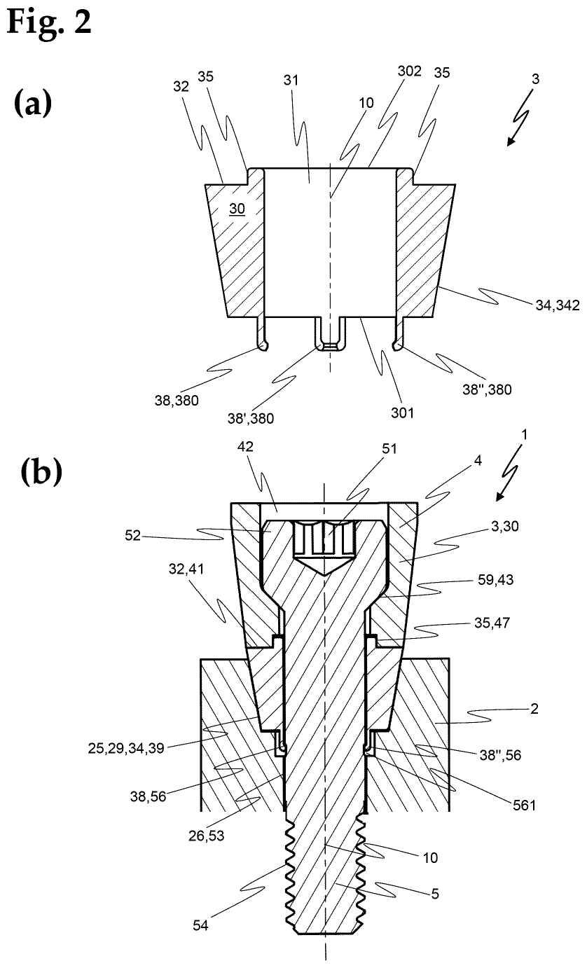

A further advantageous embodiment of a coupling part 3 according to the invention is shown in FIG. 2, both alone and installed in a dental implant 1 according to the invention.

The base 30 of the illustrated coupling part 3 according to the invention is again configured as a straight truncated cone with a corresponding conical contact portion 34; and an elongated hole 31 extends through the base 30 along a longitudinal axis 10. Four snap-in elements, of which three snap-in elements 38, 38′, 38″ are visible, are arranged at the apical longitudinal end 301 of the coupling part 3 around the opening of the elongated hole 31 and project parallel to the longitudinal axis 10 on and from the base 30.

An annular collar projects from the coronal sealing surface 32 of the coupling part 3 and serves as a guide element 35. In the assembled state of the dental implant 1, the outer lateral surface of the guide element 35 is supported on a guide element 47, which is formed as a cylindrical section on the inside of the elongated hole 42 of the abutment 4, so that radial shear forces are transmitted directly between the two components 3, 4.

The structure and function of the various elements of the illustrated dental implant 1 are analogous to the embodiment shown in FIG. 1. The assembly of the module 11 (3, 4, 5) and its installation in the base 2 is also analogous.

Due to the position of the snap-in elements 38, 38′, 38″, 38′″ of the coupling part 3, the counter-snap-in element 56 of the connection part 5 must be arranged further away from the head piece 52 and lies within the base 2 in the assembled dental implant 1. Again, only the coronal longitudinal end of the base is shown.

Due to the alignment of the snap-in elements, the shown embodiment of a coupling part 3 is particularly suitable for screwing the threaded section of the connection part 5 into the snap-in lugs, as tilting is not possible. The thread can also be used directly as a counter-snap-in element here.

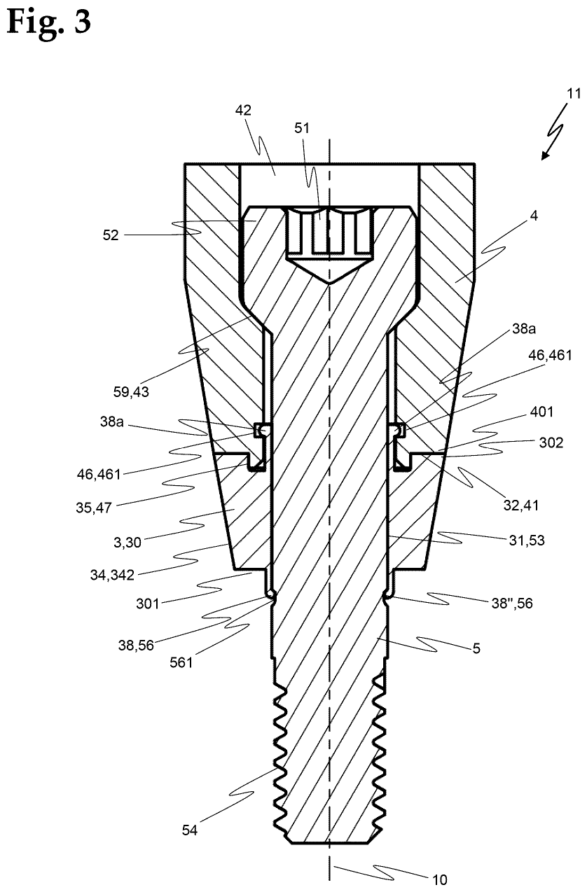

A further embodiment of a coupling part 3 according to the invention is shown in FIG. 3 as part of an assembly 11 according to the invention.

The base 30 of the coupling part 3 is configured as a straight truncated cone with a conical contact portion 34. An elongated hole 31 runs through the base 30 along the longitudinal axis 10. A group of snap-in elements 38 protrudes from the base 30 at the apical longitudinal end 301 parallel to the longitudinal axis 10, analogous to the coupling part in FIG. 2, and are latched in a counter-snap-in element 56 in the form of a circumferential snap-in groove 561 on the shaft of the connection part 5.

At the coronal longitudinal end 302 of the coupling part 3, an annular recess is arranged centered on the annular coronal sealing surface 32 and the longitudinal axis 10, which serves as a guide element 35. A guide element 47 of the abutment 4 in the form of an annular projection protrudes from the apical sealing surface 41 at an apical end 401 of the abutment 4. The radial lateral surface of the projection 47 lies flush against the radial inner wall of the recess 35. The two components 3, 4 are aligned accordingly to the common longitudinal axis 10. In the assembled dental implant, radial shear forces are also transmitted directly between the components.

In the recess 35 of the coupling part 3, a group of further snap-in elements 38a is arranged around the coronal opening of the elongated hole 31, which protrude from the bottom of the recess parallel to the longitudinal axis 10. The further snap-in elements 38a each comprise a latch hook with a resilient lever arm and a radially outwardly directed snap-in lug at the end of the lever arm. The further snap-in elements 38a are in operational connection with corresponding further counter-snap-in elements 46.

The further counter-snap-in elements 46 are realized as a common circumferential undercut snap-in groove 461 in the elongated hole 42 of the abutment 4, into which the snap-in lugs of the further snap-in elements 38a are engaged. The further snap-in elements 38a and counter-snap-in elements 46 in conjunction with the guide elements 35, 47 form a positive connection between coupling part 3 and abutment 4.

The snap-in lugs of the other snap-in elements 38a are round on both sides, so that to uncouple the two components 3, 4 it is sufficient to exert a tensile force along the longitudinal axis 10, which presses the snap-in lugs inwards at the edge of the snap-in groove 461 and thus deflects the resilient lever arms radially inwards.

To construct the assembly 11, in a first step a coupling part 3 and an assembly part 4 are placed on top of each other or inserted and latched and thus reversibly positively connected to each other. In a second step, a connection part 5 is pushed from a coronal end 402 of the abutment 4 along the longitudinal axis 10 through the elongated holes 31, 42 of the abutment 4 and coupling part 3 until the snap-in lugs of the snap-in elements 38 engage in the counter-snap-in element 56 of the connection part 5 in the form of a circumferential snap-in groove 561.

In the embodiment example shown, the further snap-in elements 38a are arranged in such a way that when the connection part 5 is inserted into the elongated holes 31, 42, the inside of the lever arms of the latch hooks of the further snap-in elements 38a rest against the connection part 5. Radial inward deflection of the additional snap-in elements 38a is no longer possible once the connection part 5 has been inserted. Accordingly, the coupling part 3 and the abutment 4 can only be decoupled again once the connection part 5 has been removed.

The assembly of the subassembly 11 according to the invention on a base is analogous to the previously discussed embodiments.

Since the coupling part 3 and the abutment 4 can be handled as a common component in the reversibly coupled state, the design example shown is particularly advantageous if a abutment 4 is to be equipped in advance with a coupling part 3 that matches the intended base.

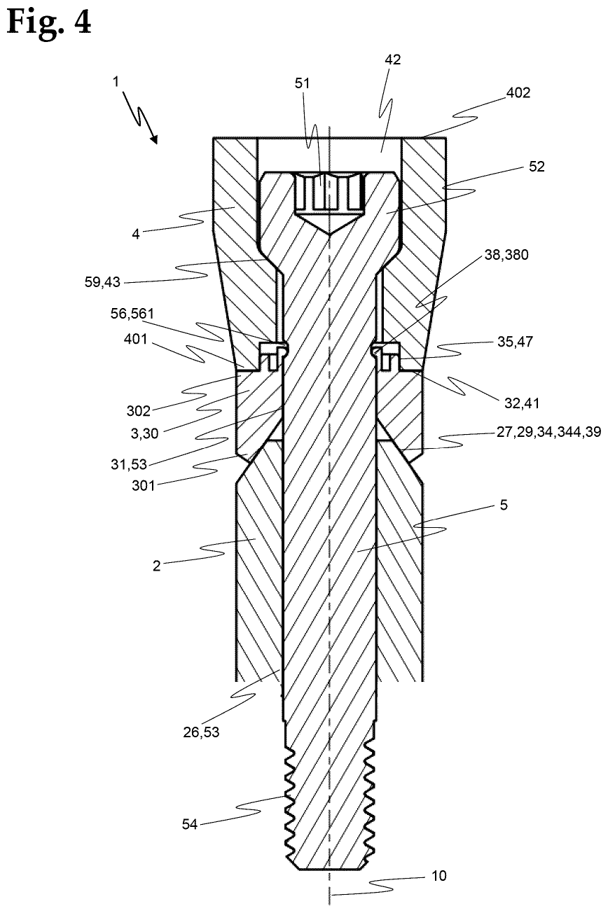

Another embodiment of a coupling part 3 according to the invention as part of a fully assembled dental implant 1 is shown in FIG. 4.

The assembly of the subassembly 11 according to the invention and the dental implant 1 is essentially analogous to the embodiments disclosed above.

The coupling part 3 has a base 30 with an elongated hole 31. The contact portion 34 of the coupling part 3 is formed by the conical-inverse lateral surface 344 of a straight-conical recess at an apical longitudinal end 301 of the coupling part 3. The contact portion 34 rests on the surface of a straight-conical support 27 at the coronal end of the base 2, so that the interior of the dental implant 1 is sealed at this contact point 29, 39. The apical end of the base is again not shown for the sake of clarity.

An annular sealing surface 32 is arranged at the coronal end 302 of the base 30, and a guide element 35 in the form of an annular projection protrudes from the base 30. On the apical side 401 facing the coupling part 3, a abutment 4 has an annular apical sealing surface 41, which rests on the coronal sealing surface 32 of the coupling part, so that the two components 3 and 4 are sealingly connected to each other at this contact point. A cylindrical recess in the center of the apical sealing surface 41 serves as a guide element 47. The guide element 35 lies flush with the outer lateral surface on the inside of the recess 47. As in the embodiments already discussed, the radially abutting guide elements 35, 47 on the one hand ensure correct alignment during assembly of the subassembly, and on the other hand transmit radial shear forces between the two components 3, 4 in the assembled dental implant 1.

Distributed around the coronal opening of the elongated hole 31 are several snap-in elements 38 in the form of latch hooks 380 aligned along the longitudinal axis 10. The snap-in lugs of the latch hooks are engaged in a counter-snap-in element 56 of the connection part 5 in the form of a circumferential snap-in groove 561.

A threaded section 54 of the shaft of the connection part 5 is screwed into the internal thread (not shown) of the base 2. The coupling part 3 and the abutment 4 are positively fixed between the head piece 52 of the connection part 5 and the conical support 27 of the base 2 and braced against each other in the longitudinal direction 10 by the connection part 5.

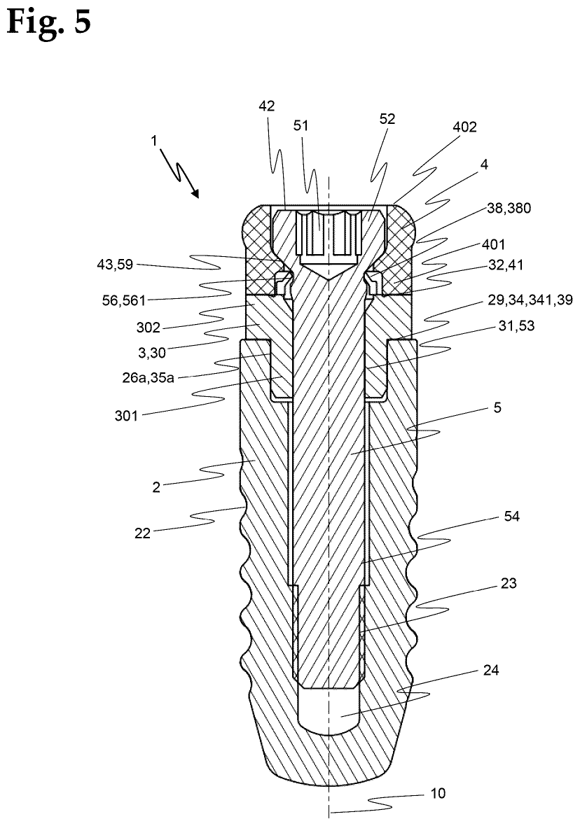

FIG. 5 shows a further embodiment of a coupling part 3 according to the invention as part of a dental implant 1. The coupling part 3 is again suitable for connecting the base 2 of the dental implant 1 to the abutment 4 of the dental implant 1.

As in the embodiments described above, the coupling part 3 comprises the base 30 with an elongated hole 31 along the longitudinal axis 10 of the base 30. A plurality of snap-in elements 38 are arranged on the base 30. The snap-in elements 38 are suitable for entering into a snap-in operational connection with the at least one counter-snap-in element 56 of the connection part 5 which can be arranged in the elongated hole 31. In the embodiment example, the contact portion 34 on the base 30 of the coupling part 3 for the sealed support 29, 39 of the coupling part 3 on the base 2 is configured as a flat surface 341 perpendicular to the longitudinal axis 10 of the base 30, which rests on an analogous flat support surface 341 at the coronal end of the base 2.

As shown in the embodiment example, several flat surfaces can be arranged in the axial direction. Preferably, the contact portion 34 on which the coupling part rests sealingly 29, 39 on the base 2 is as close as possible to the oral cavity, or the contact portion 34 is radially as far away as possible from the longitudinal axis 10 of the base 30. This prevents the penetration of bacteria into the dental implant 1 or parts of the implant as completely as possible.

The other flat surfaces can be used to position or align the coupling part 3 relative to the base 2. Due to the flat surfaces 341 of the contact portion 34, forces which arise, for example, when chewing with the dental implant 1 and which act along the longitudinal axis 10 of the dental implant 1 are transmitted directly from the coupling part 3 to the base 2 without generating transverse forces which act radially. This is particularly advantageous for ceramic components, as these can absorb compressive forces very well, but are less suitable for shear or tensile forces.

In the assembled or coupled state, the apical sealing surface 41 of the abutment 4 rests on the coronal sealing surface 32 of the coupling part 3 and forms a coronal contact portion, so that the dental implant 1 is sealed at this contact point of the two components 3, 4. Similarly, in the assembled or coupled state, the apical sealing surface 39 of the coupling part rests on the coronal sealing surface 29 of the base 2 and forms a contact portion 34, so that the dental implant 1 is sealed at this contact point of the two components 2, 3.

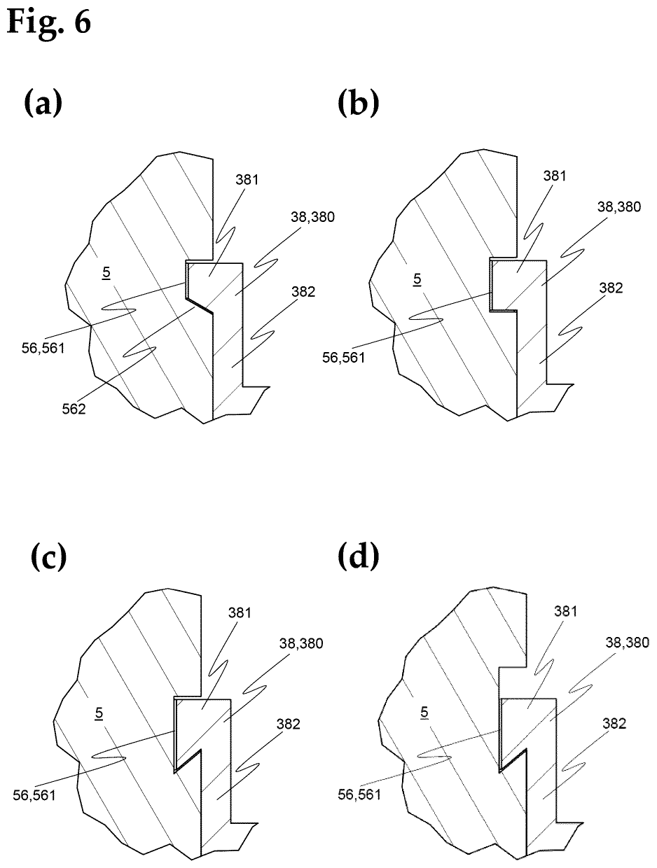

The snap-in connection described above between the snap-in elements 38, 38′, 38″, 38′″ of a coupling part and the counter-snap-in element 56 of a connection part 5 or the further snap-in elements 38a, 38a′ and the further counter-snap-in element 46 can be configured to be both reversible and irreversible. Different variants of such snap-in connections are shown in FIG. 6.

A reversibly releasable snap-in connection is shown in FIG. 6(a). A snap-in element 38 of a coupling part 3 is configured as a latch hook 380, with a spring-elastic lever arm 382 and a snap-in lug 381 attached to the free end of the lever arm. The snap-in lug 381 is engaged in a counter-snap-in element 56 of a connection part 5, wherein the counter-snap-in element 56 is configured as a snap-in groove 561.

The snap-in lug 381 has a ramp inclined to the axis of the lever arm on a side facing the lever arm, and an end face perpendicular to the axis of the lever arm on the side facing away from the lever arm. Similarly, the snap-in groove 561 has a ramp 562 on one side and a vertical wall on the other side. Such a snap-in connection can be released again by applying a tensile force acting downwards along the lever arm, which is sufficient to deflect the snap-in lug 381 on the ramp 562 outwards in a sliding manner, overcoming the corresponding radial spring force of the lever arm 382.

A loosening of the connection can be prevented, for example, by blocking or preventing a deflection of the snap-in element, for example by not providing the space for radial deflection of the snap-in lug 381 from the snap-in groove 461, 561. This can be achieved, for example, by inserting a connection part 5 into the elongated hole so that the snap-in elements are blocked in the radial direction. Thus, the connection between the coupling part 3 and the abutment 4 can only be released again after the connection part 5 has been removed from the elongated hole 31.

A conditionally reversibly releasable snap-in connection is shown in FIG. 6(b). Both the two end faces of the snap-in lug 381 of the snap-in element 38 and the two walls of the snap-in groove 561 of the counter-snap-in element 56 are aligned perpendicular to the axis of the lever arm. Such a snap-in connection does not necessarily release without destruction, even under tension. However, it is possible to deflect the lever arm 382 radially using a suitable tool, for example, in order to lift the snap-in lug 381 out of the snap-in groove 561 and thus release the snap-in connection again.

FIG. 6(c) shows a snap-in connection that cannot be released in the longitudinal direction, as it is created in the form of a bayonet catch. The lower wall of the snap-in groove 561 is undercut at an angle. The end face of the snap-in lug 381 on the side of the lever arm 382 in turn has an inverted ramp.

To close the snap-in connection, the connection part 5 and the coupling part 3 are coupled by a certain angle in the longitudinal axis, analogous to a bayonet lock, whereby a non-undercut snap-in recess (not shown) in the connection part 5, analogous for example to FIG. 6(b), accommodates the snap-in lug 561. This recess is connected along the circumference to an undercut snap-in groove 561, so that by rotating the connection part 5 relative to the coupling part 3 about the longitudinal axis, the snap-in lug 381 is turned into the undercut snap-in groove 561.

When pulled, the snap-in lug 381 is deflected towards the connection part. Non-destructive, reversible release of the snap-in connection is therefore not possible. It is also not possible to release the snap-in connection under pressure, as the snap-in lug 381 is held positively in the undercut snap-in groove 561. The snap-in connection can only be released by unscrewing the snap-in lug 381 from the snap-in groove 561 into the non-undercut recess of the connection part 5, but this requires deliberate manipulation.

Finally, FIG. 6(d) shows a snap-in connection that is also essentially non-detachable. The lower wall of the snap-in groove 561 is undercut at an angle. The end face of the snap-in lug 381 on the side of the lever arm 382 has an inverted ramp.

When pulled, the snap-in lug 381 is deflected towards the connection part. Non-destructive, reversible release of the snap-in connection is therefore not possible. Manual release of the snap-in connection is also not possible, as the snap-in lug 381 is held positively in the undercut snap-in groove 561.

Non-detachable or conditionally detachable snap-in connections have the advantage that the components of the assembly do not inadvertently detach from each other when removing an assembly 11 from the dental implant. A reversible snap-in connection, on the other hand, has the advantage that an assembly 11 can be disassembled more easily after assembly.

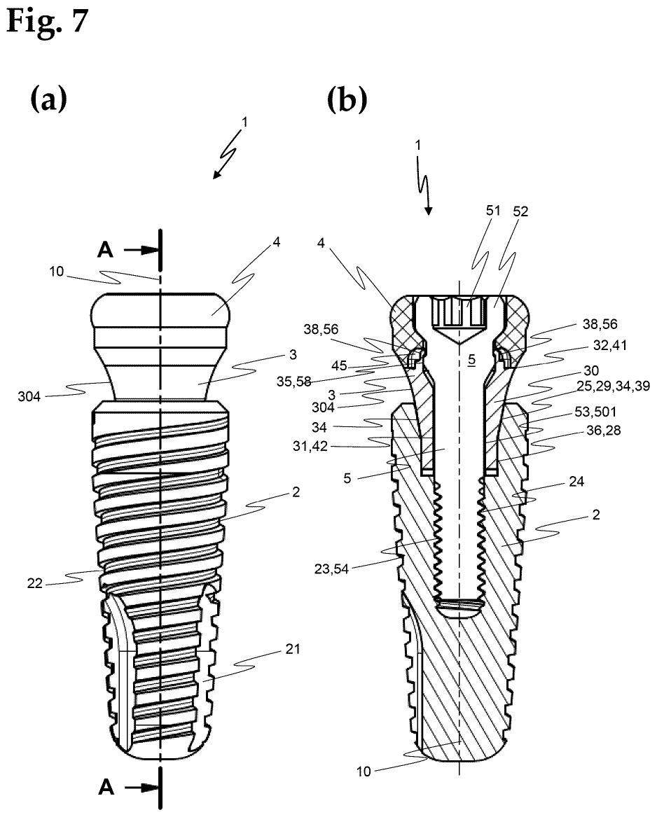

A further advantageous embodiment of a dental implant 1 according to the invention and its individual parts is described in FIGS. 7, 8 and 9.

A base 2 of the dental implant 1 comprises a conical external thread 22 and, in an apical region, an upstream cutting thread 21 for the external thread. The base 2 is implanted into the bone tissue of a patient by screwing the cutting thread 21 and the subsequent external thread 22 into a prepared hole in the bone tissue. A blind hole 24 with a cylindrical internal thread 23 is arranged along a longitudinal axis 10 in the base 2. A receptacle 25 in the form of an inverted straight truncated cone is arranged in the area of the coronal opening of the blind hole. An anti-rotation section 28 can be arranged between the internal thread 23 and the conical receptacle 25, for example, as in the embodiment example shown.

In the embodiment example shown, the base 30 of a coupling part 3 comprises an anti-rotation section 36 at its apical longitudinal end 301, a central contact portion 34 in the form of a straight truncated cone, and a transition section 304 at its coronal longitudinal end 302. An elongated hole 31 extends along the longitudinal axis 10. At the coronal longitudinal end 302 of the coupling part 3, an annular sealing surface 32 is arranged at the outer edge in a plane perpendicular to the longitudinal axis 10. Four snap-in elements 38, 38′, 38″, 38′″ protrude from the coronal end face parallel to the longitudinal axis, in the form of a latch hook 380 with a lever arm 382 and a snap-in lug 381 directed towards the longitudinal axis 10.

Alternatively, the contact portion 34 can also have the shape of a curved truncated cone. The receptacle 25 of the base 2 can then also be configured with a corresponding conical curvature.

Contact portion 34 and transition section 304 can also be formed as sections of a common straight or curved truncated cone.

A abutment 4 has an elongated hole 42, with a first receptacle 44 at a coronal longitudinal end 402 of the abutment 4, a second receptacle 45 at an apical longitudinal end 401, and a conical support surface 43 arranged therebetween. At the apical longitudinal end 401, an annular sealing surface 41 is present around the second receptacle 45 in a plane perpendicular to the longitudinal axis 10. At the coronal longitudinal end 402, the abutment 4 is configured as a locator of a locator fastening system, with an annular bead 48.

A connection part 5 comprises a cylindrical shank 57 and a head piece 52. The shank 57 has a threaded section 54 at one apical end and a support section 53 adjoining it. In the example shown, the head piece 52 has an engagement means 51 in the form of a recess with a star-shaped inner contour, which can be engaged with a suitable turning tool in order to exert a rotational force about the longitudinal axis 10 of the connection part 5. A guide section 58, a counter-snap-in element 56 in the form of a circumferential snap-in groove 561 and a conical contact portion 59 are arranged between the support section 53 and the head piece 52.

In the assembled dental implant 1, the contact portion 34 of the coupling part 3 lies flush and sealed on the surface of the, for example, conical receptacle 25 of the base 2. This results in radial support of the two components 2, 3 and sealing of the interior of the dental implant 1 at the corresponding contact point of the components 2, 3. The outer contour of the anti-rotation section 36 of the coupling part 3 can interact positively with an inner contour of the anti-rotation section 28 of the base 2, so that the rotational alignment of the coupling part 3 to the base 2 is fixed. Depending on the design of the contours of the corresponding anti-rotation sections 28, 36, several or just one alignment is possible.

The apical sealing surface 41 of the abutment 4 lies on the coronal sealing surface 32 of the coupling part 3, so that the dental implant 1 is sealed at this contact point of the two components 3, 4. The transition section 304 of the coupling part 3 forms an essentially edgeless surface with the adjoining lateral surface of the abutment 4. The latch hooks 380 of the four snap-in elements 38, 38′, 38″, 38′″ are engaged in the snap-in groove 561 of the counter-snap-in element 56 of the connection part 5.

In the assembled dental implant 1, the threaded section 54 of the connection part 5 is screwed into the internal thread 23 of the base 2. The support section 53 of the connection part 5 is supported on the inside of the elongated hole 31 of the coupling part 3.

Similarly, the guide section 58 of the connection part 5 is supported radially on the guide element 35 of the coupling part 3. The conical contact portion 59 of the connection part 5 rests on the support surface 43 of the abutment 4. The abutment 4 is thus supported radially on the connection part 5. In contrast to the previously discussed embodiments of the invention, there is no radial support of the abutment 4 directly on the coupling part 3. Instead, radial shear forces are transmitted indirectly from the abutment 4 to the base 2 via the connection part 5.

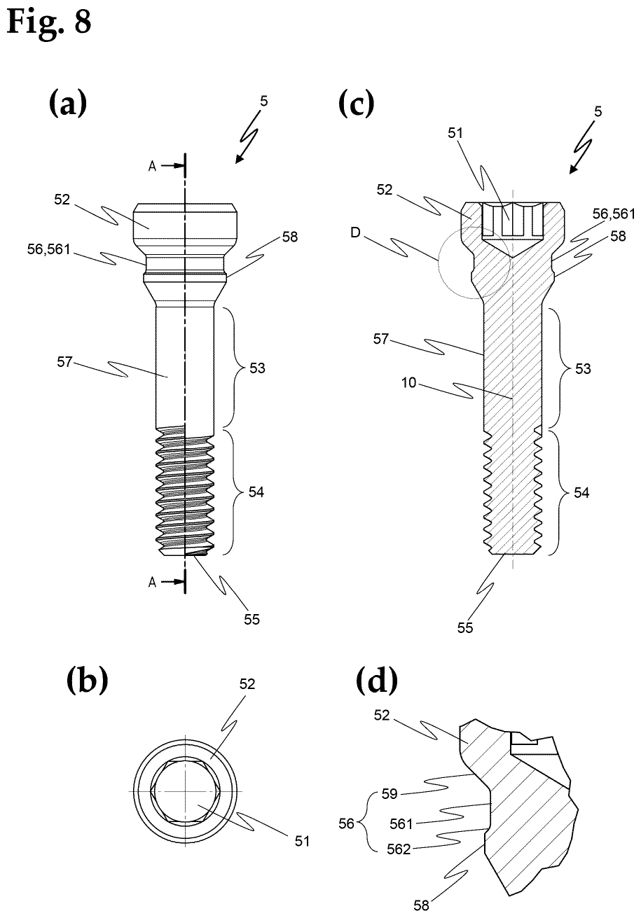

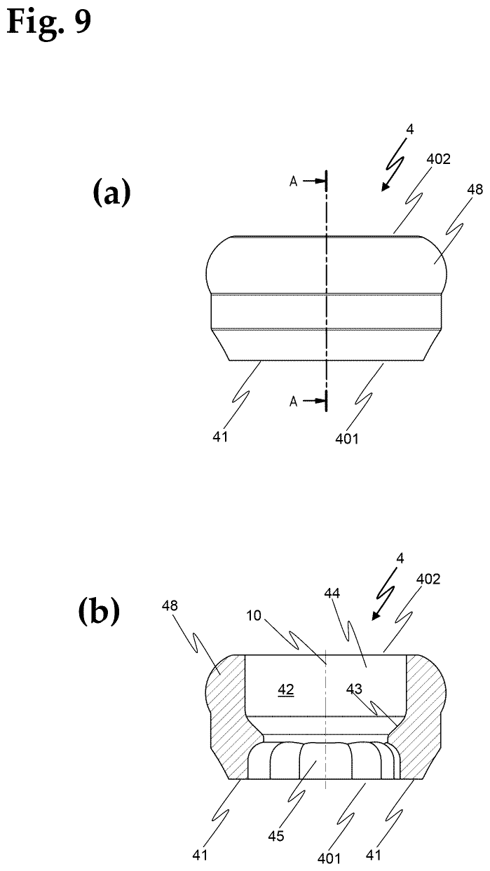

Another advantageous embodiment of an assembly 11 according to the invention and its individual components is disclosed in FIG. 10. The abutment 4 of the dental implant 1 shown is identical to the abutment 4 of FIG. 9. This shows that a coupling part 3 according to the invention advantageously allows an abutment 4 to be connected to different types of base bodies 2 by providing a coupling part adapted to the abutment and the base to be combined therewith.

A coupling part 3 has a base 30 with an elongated hole 31 along the longitudinal axis 10. The base 30 comprises an outer contact portion 34 and a cylindrical contact portion 37. The contact portion 34 has the shape of a curved truncated cone. At the coronal longitudinal end 302 of the coupling part 3, an annular coronal sealing surface 32 is arranged at the outer edge in a plane perpendicular to the longitudinal axis 10. Parallel to the longitudinal axis, four snap-in elements 38, 38′, 38″, 38′″ protrude from the coronal end face in the form of a latch hook 380 with a lever arm 382 and an inwardly directed snap-in lug 381.

The contact portion 34 of the coupling part 3 is intended to lie flush and sealed on the surface of an analogously shaped curved-conical receptacle 25 of a base 2 in an assembled dental implant. This results in radial support of the two components and sealing of the interior of the dental implant at the corresponding contact point of the components. The contact portion 37 coupling part 3 is intended to be supported radially on an inner wall of a cylindrical contact portion of a base 2.

With regard to abutment 4, please refer to the corresponding comments on FIG. 9.

A connection part 5 comprises a cylindrical shank 57 and a head piece 52. The shank 57 has a threaded section 54 at one apical end, and a support section 53 adjoining it. The head piece 52 can, as in the embodiment example shown, have an engagement means 51 in the form of a recess with a star-shaped inner contour, which can be engaged with a suitable turning tool. A counter-engagement element 56 is arranged between the support section 53 and the head piece 52. As shown, this can take the form of a circumferential snap-in groove 561 and a conical contact portion 59.

In the assembled assembly 11, the apical sealing surface 41 of the abutment 4 rests in a contact portion on the coronal sealing surface 32 of the coupling part 3, so that in the fully assembled state the dental implant 1 is sealed at this contact point of the two com-ponents 3, 4. The latch hooks 380 of the snap-in elements 38, 38′, 38″, 38′″ are engaged in the snap-in groove 561 of the counter-snap-in element 56 of the connection part 5. An upper part of the support section 53 of the connection part 5 is supported on the inside of the elongated hole 31 of the coupling part 3. The conical contact portion 59 of the connection part 5 rests on the conical support surface 43 of the superstructure part 4, which is thus supported radially on the connection part 5.

The threaded portion 54 of the coupling part 5 is intended to be screwed into an internal thread of a base 2. A lower part of the support section 53 of the connection part 5, which is not located inside the coupling part 3, can be provided to lie flush in a threadless portion of the blind hole of a base 2 on the inner wall.

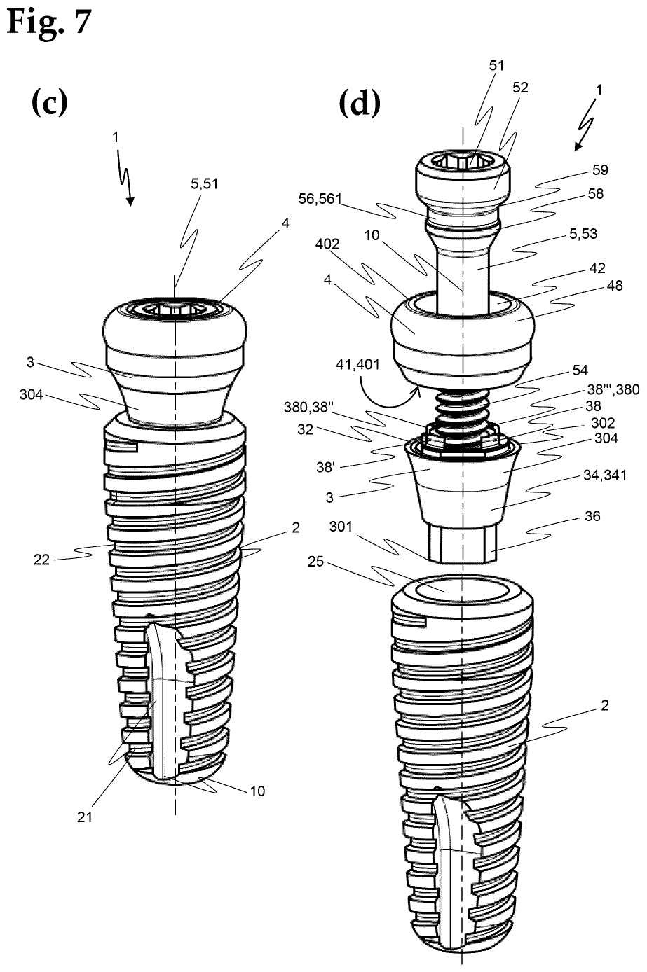

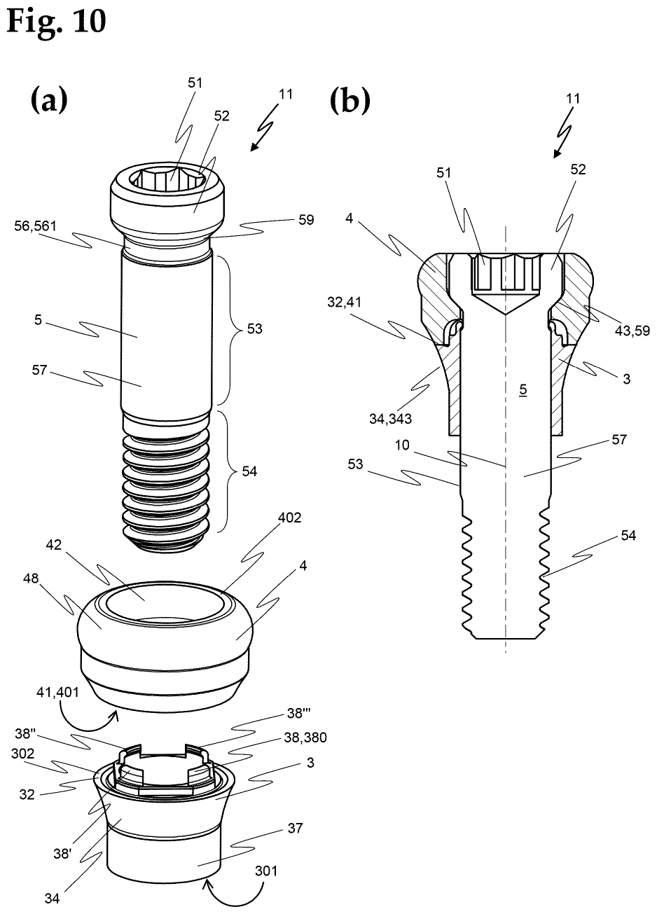

FIG. 11 shows a further advantageous embodiment of a coupling part 3 according to the invention, which is suitable for being assembled with a connection part 5 and a abutment 4 according to FIGS. 8 and 9 already discussed to form an assembly according to the invention.

The main body 30 of the illustrated coupling part 3 comprises a curved-conical contact portion 34 and an adjoining cylindrical contact portion 37. The contact portion 34 and the cylindrical contact portion 37 are intended to be in operational connection with a curved-conical receptacle or with an adjoining contact portion of a base, as discussed in the previous embodiment example.

An elongated hole 31 extends along the longitudinal axis 10 from an apical longitudinal end 301 to a coronal longitudinal end 302. An annular sealing surface 32 extends along the outer edge of the coronal end face of the coupling part 3. Three guide elements 35, 35′, 35″ are formed from a cylindrical projection. On the one hand, these guide elements permit correct insertion of the coupling part 4 into a corresponding apical recess 45 of the abutment 4. On the other hand, in an assembled dental implant, a guide section 58 of the connection part 5 is supported radially on the lower, continuous lateral surface 351 of the guide elements.

Three snap-in elements 38, 38′, 38″ are arranged between the guide elements. The snap-in elements in the form of a latch hook 380 each comprise a resilient spring arm 382 and a snap-in lug 381 pointing towards the inside, which is intended to latch into the snap-in groove 561 of the snap-in element 56 of the connection part 5.

Like the coupling parts 3 according to the invention already discussed, the coupling part 3 shown is also preferably made of metal, in particular titanium or a titanium alloy. The guide elements 35 and the snap-in elements 38, 38′, 38″ can be manufactured, for example milled, from the cylindrical projection. If the transition between the guide element 35, 35′, 35″ and the coronal longitudinal end 302 of the coupling part 3 has a corner radius, the abutment 4cannot rest tightly on the coupling part 3. Such a corner radius can occur, for example, if the machining tool is not or no longer sharply ground. Since the inner walls of the elongated hole 42 of the abutment 4 rest against the guide elements 35, 35′, 35″, the lower part of the elongated hole 42 rests on the corner radius. As a result, the apical sealing surface 41 of the abutment 4 could not rest tightly on the coronal sealing surface 32 of the coupling part 3. In addition, the centering length or the guide length of the abutment 4 on the guide elements 35, 35′, 35″ would be shortened by the corner radius. A rotary undercut 303 is therefore preferably arranged at the base of the guide elements 35, 35′, 35″. The rotary undercut 303 at the coronal longitudinal end 302 of the coupling part 3 in the region of the guide element 35, 35′, 35″ can prevent a radial transition between the guide element 35, 35′, 35″ and the coronal end 302 of the coupling part 3 from preventing the abutment 4 from resting tightly on the coronal sealing surface 32 of the coupling part 3 and thus, for example, bacteria from penetrating between the coupling part 3 and the abutment 4. In addition, the guide element 35, 35′, 35″ thus serves to guide and align the coupling part 3 and the abutment 4 over its entire height. The rotary undercut 303 also prevents a sharp right angle between the guide element 35 and the coronal sealing surface 32 (see FIG. 11(f)). Right angles are unfavorable in terms of stress, as they have a certain notch effect, which is susceptible to cracks, especially hairline cracks, under load. Furthermore, the coronal sealing surface 32 can be completely machined by the rotary undercut 303, for example with a grinding wheel. The rotary undercut 303 defines the limit of the sealing surface.

Alternatively or in addition to the rotary undercut, a transition radius can be provided at the apical end of the abutment 4 at the edge to the elongated hole 42 of the abutment 4 so that the apical sealing surface 41 of the abutment 4 can rest on the coronal sealing surface 32 of the coupling part 3. As a result, the dental implant 1 is sealed at the contact point of the two components 3, 4 in the assembled state.

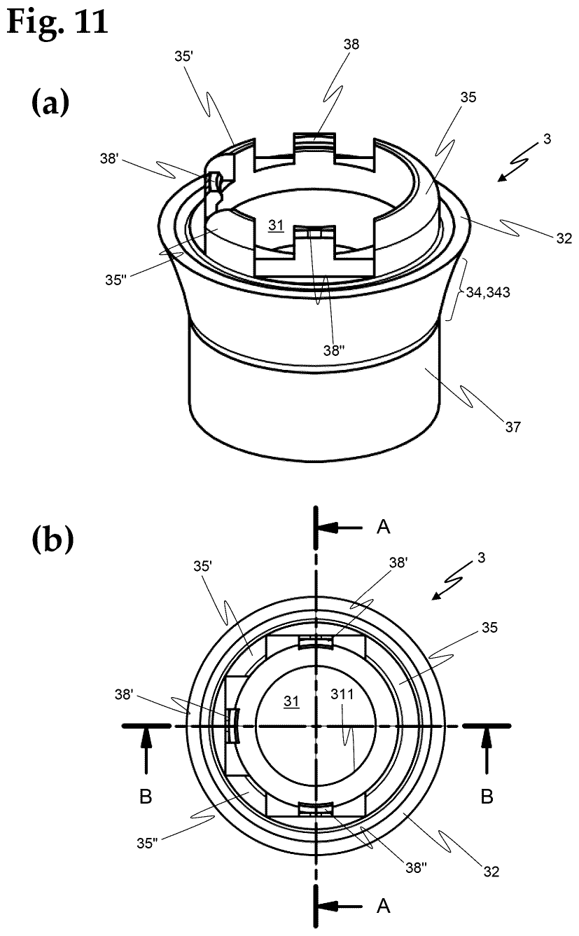

Instead of an abutment 4, to which another component can be attached if necessary, as in the previous embodiments, a superstructure 6 can also be connected directly to the coupling part 3. The superstructure 6 can thus also be seen as a abutment 4. For example, FIG. 12(a) shows an assembly 11 comprising a superstructure 6 in the form of a single-tooth prosthesis or a crown, as well as a coupling part 3 as shown in FIG. 11 and a connection part 5 as shown in FIG. 8. The superstructure 6 thus corresponds to an integral component with abutment and structure. The engagement means 51 of the connection part 5 is accessible from above through an elongated hole 62. After final assembly, the elongated hole 62 can be filled.

FIG. 12(b) shows an assembly 11 with a superstructure 6 in the form of a healing element, namely a gingiva former. Such a component is temporarily mounted on the base after implantation of a base in the bone tissue of a patient, on the one hand to close off the interior of the dental implant, and on the other hand to shape the gingiva during healing of the base and accordingly also to serve as a placeholder for the final structure.

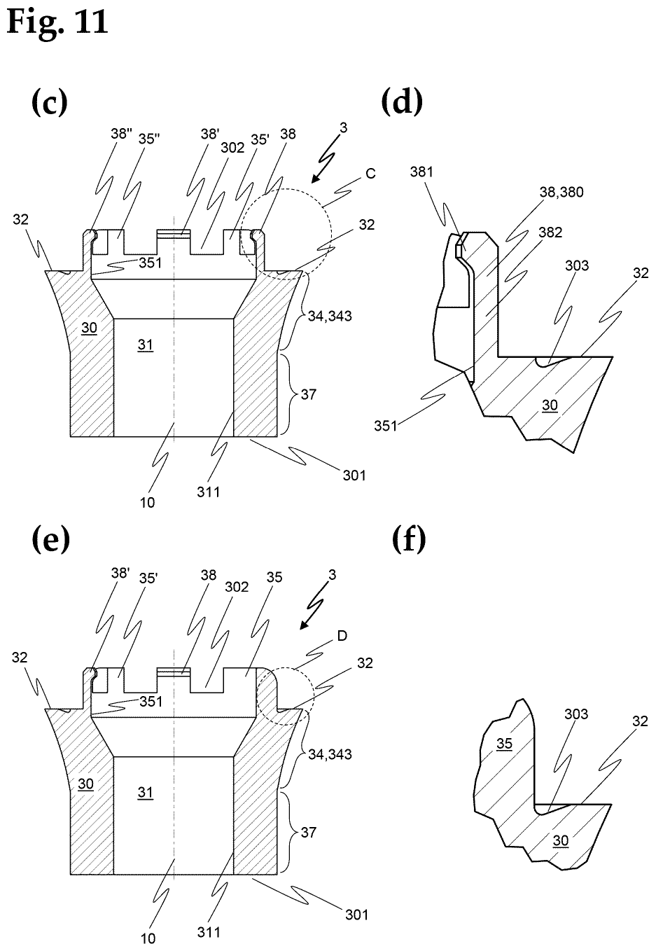

Further embodiments of the present invention are also shown in FIGS. 13 to 17 and their description.

FIG. 13 shows an assembly 810, also called a set, in the assembled state, comprising a abutment 730, a connection part 732, also called a retaining screw, and a coupling part 740, also called an adapter, for connection to a base 720.

The base 720 is intended to be permanently inserted and screwed into a jawbone and has an external thread with which the base can be screwed into a previously drilled blind hole in the jawbone during implantation. The external thread is not shown in the purely schematic drawing in FIG. 13.

Furthermore, the base 720 has a cylindrical blind hole 742 which extends parallel to a longitudinal axis L of the base and is open towards a conical receptacle 744, also referred to as the coronal end of the base. The blind hole 742 comprises an internal thread 746 which, in the assembled state of the assembly 810, engages with an apical threaded portion 748, also referred to as the external thread of the connection part 732. The blind hole 742 widens towards the outside in the shape of a cone and thus forms a conical receptacle 744 of the base.

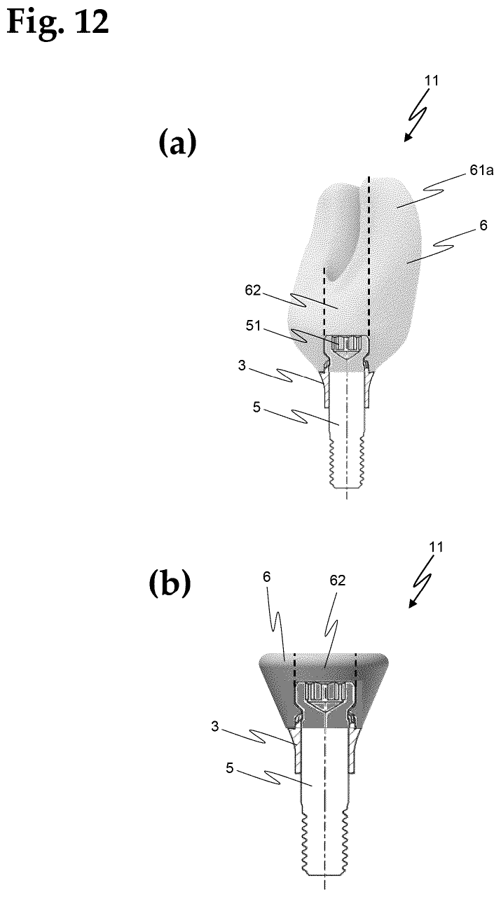

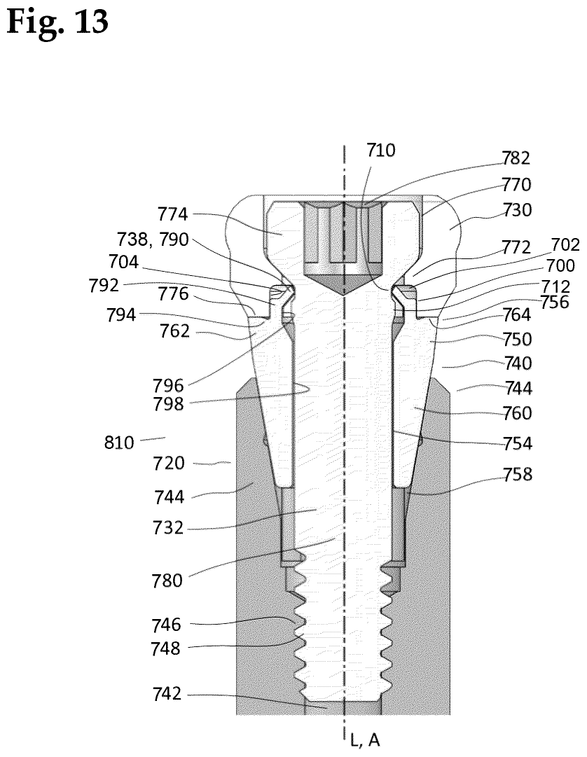

As also shown in FIG. 14 and FIG. 15, the coupling portion 740 includes a body 750 having an elongated hole 754, also referred to as a cylindrical through hole. The elongated hole 754 extends along a longitudinal axis A of the coupling member from a coronal end 756 to an apical end 758 of the coupling member and is adapted to receive the connecting member 732. The coupling part 740 has an implant connection geometry for connecting the coupling part to the base in the form of a frustoconical contact portion 760, also called apical section, the conical lateral surface of which rests on a conical lateral surface of the conical receptacle 744 in the assembled state.

Adjacent to the contact portion 760, the coupling part 740 comprises a frustoconical transition section 762, also called a coronal section, with a second cone angle which is smaller than a first cone angle of the contact portion 760.

The transition section 762 is delimited by a coronally aligned, annular coronal sealing surface, also called support surface 764, arranged at the coronal end 756 for receiving the abutment 730, also called prosthetic abutment, the support surface extending in a plane perpendicular to the longitudinal axis A of the coupling part.

The coupling part is one-piece and integral.

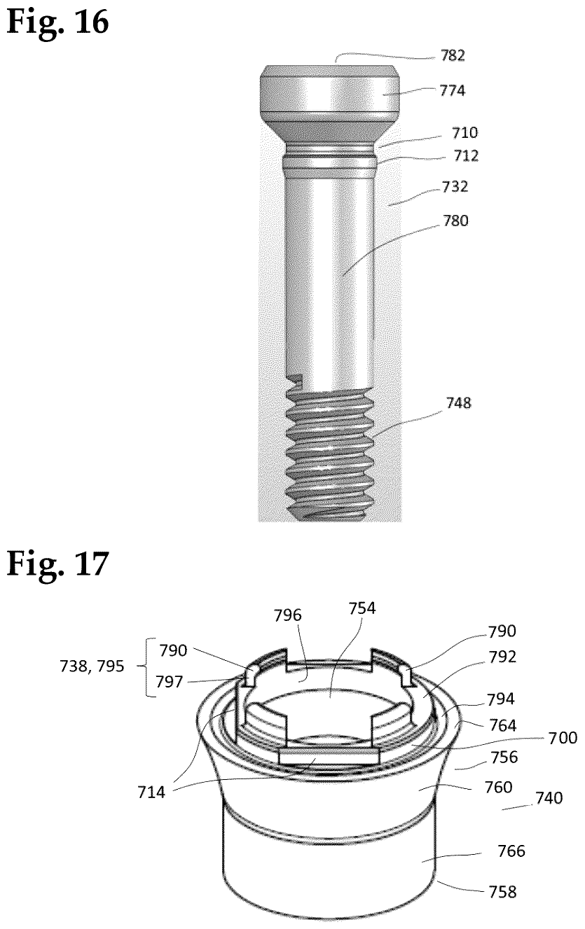

The base 720, the connection part 732 and the coupling part 740 are essentially rotationally symmetrical. In the embodiment of FIGS. 13 to 15, a abutment connection geometry for connecting the coupling part to the abutment is also rotationally symmetrical. In the embodiment shown in FIG. 17, this is not the case, as explained below.

The abutment 730 also has an elongated hole 770, also called a cylindrical through hole, the elongated hole 770 having a conical support surface 772, also called an abutment, in the form of a circumferential shoulder for receiving a head piece 774, also called a head region, of the connection part 732. Coronally, the abutment 730 is limited by an interface which is intended to receive a superstructure, for example a crown. The conical support surface is arranged axially in such a way that the head portion 774 does not protrude beyond the interface. Apically, the abutment 730 has an apical longitudinal end, also called end surface 776, which runs complementary to the coronal sealing surface 764 of the coupling part, in the present case, in the assembled state, in a plane running at right angles to the longitudinal axis A of the coupling part.

In the present case, the assembled state refers to the state of the assembly in which the connection part 732 is inserted into the elongated hole 770 of the abutment 730 and into the elongated hole 754, also referred to as the through hole, of the coupling part, wherein the at least one snap-in lug 790 of the coupling part is latched into the counter-snap-in element 710, also referred to as the snap-in recess of the connection part 732. This thus denotes the state of the assembly in which the connection part 732, the superstructure part 730 and the coupling part 740 are connected to one another, possibly loosely, and can be manipulated as one assembly.

In the assembled state, the elongated hole 770 of the superstructure part and the elongated hole 754 of the coupling part are coaxial to each other. In this case, the longitudinal axis of the coupling part A, the longitudinal axis of the connection part and the longitudinal axis of the base L coincide. Furthermore, the connection part 732 can hold the superstructure part 730, in particular the apical longitudinal end 776, fixed against the coronal sealing surface, 764, of the coupling part.

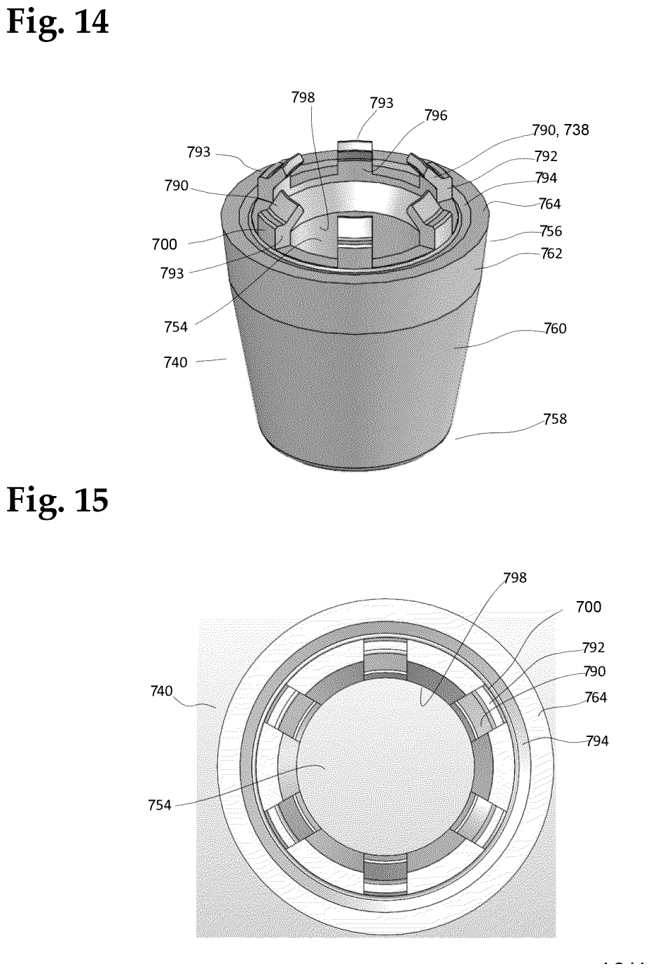

The connection part 732 serves to positively and non-positively fasten the assembly 810 to the base 720. The connection part 732 in FIG. 16 comprises a cylindrical shaft, also called a bolt 780, with the apical threaded section 748 and the head piece 774. In the example shown, the head piece 774 has an engagement means 782, also called a con-cave recess for a hexagon wrench, so that the connection part 732 can be screwed in and out. The skilled person is also aware of other ways of bringing a connection part 732 into operational connection with a screwing tool. The connection part 732 is advantageously made of metal.

The inner diameter of the elongated hole 754 of the coupling part 740 is selected such that, when the assembly 810 is installed, a threadless section of the shaft 780 lies flush in the elongated hole 754. The connection part 732 pulls the superstructure part 730, the coupling part 740 and the base 720 together with a certain tensile force, so that the apical longitudinal end 776 of the superstructure part 730 is pressed against the coronal sealing surface 764 of the coupling part 740 and the conical contact portion 760 of the coupling part is pressed into the conical receptacle 744 of the base. This results in a firm and force-snap-in connection between the abutment 730, the coupling part 740 and the base 720, which also seals the interior of the assembly consisting of the blind hole 742 and the elongated hole 754.

The superstructure, for example a ceramic dental crown, can then be mounted, for example by bonding, on the superstructure part 730 on the assembly 810, which is positively and non-positively attached to the base 720 as shown in FIG. 13. Advantageously, this superstructure seals the abutment 730 from the outside, so that the connection part 732 comes to lie completely inside the assembly 810.

The coupling part 740 comprises a plurality of snap-in elements 738, as also shown in FIG. 14 and FIG. 15. The snap-in elements 738 comprise a snap-in lug 790, which extend obliquely from a guide element 792, also called carrier element, in the direction of the elongated hole. The plurality of snap-in lugs 790 are intended to latch into the counter-snap-in element 710 of the connection part below the head piece 774 when the connection part 732 is inserted into the elongated hole.

The guide element 792 forms a cylindrical ring, which is arranged radially inwards towards the coronal sealing surface 764 of the coupling part 740, extends axially apically and adjoins the elongated hole 754 of the coupling part. The guide or carrier element 792 acts as a guide element analogous to the guide elements 35 as described above. The guide elements 792 are interrupted and comprise guide segments 793. In the present case, six guide segments 793 are formed, which are equally spaced from one another in the circumferential direction and are formed in the same way. Thus, the guide element 792 has an interrupted, cylindrical, radially inner wall surface 796, which, viewed in the radial direction, is offset radially outwards towards the wall surface 798 of the elongated hole 754 of the coupling part. Furthermore, the guide element 792 has an interrupted, radially outer wall surface 700.

The guide element 792 is intended to be inserted into a second receptacle 702, also referred to as apically arranged receptacle opening 702 of the superstructure part 730, wherein the wall surface 704 of the second receptacle 702 is formed complementary to the radially outer wall surface 700 of the guide element 792.

A rotary undercut 794, also known as a circular groove, surrounds the guide element 792 radially outwards and extends, viewed in the radial direction, from the radially outer wall surface 700 of the guide element 792 to the coronal sealing surface 764 of the coupling part. The rotary undercut 794 has a roundish cross-section and forms a separation of the guide element 792 from the coronal sealing surface 764 of the coupling part.

The plurality of snap-in lugs 790, here six snap-in lugs, protrude from the guide element 792, in particular from a guide segment 793 in each case, and are equally spaced from one another in the circumferential direction.

In the present case, the complementary structure of the connection part 732 is in the form of a counter-engagement element 710, which extends circumferentially in a circle below the head piece 774. A guide section 712, also referred to as a circumferential thickening of the connection part, is provided in the form of a bead to delimit the counter-engagement element 710 apically. The diameter of the connection part can be the same in the region of the counter-engagement element 710 as in the region of the shaft 780. The diameter of the connection part is smaller in the region of the counter-engagement element and larger apically to the counter-engagement element in the region of the guide section 712 in order to prevent apical movement of the engaged snap-in lugs 790. In this regard, it should also be mentioned that the length of the snap-in lugs are dimensioned such that they remain in contact with the connection part 732 in the assembled state. Furthermore, the end of the snap-in lugs 790 facing the connection part 732 lies in a plane running perpendicular to the longitudinal axis A of the coupling part.

When the connection part 732 is inserted into the elongated hole 770 of the superstructure part, the connection part 732 can be inserted into the elongated hole 754 of the coupling part until the plurality of snap-in lugs 790 engage with the generatrix element 710. As a result, the superstructure part 730 remains held between the head piece 774 of the connection part 732 and the coupling part 740, so that the superstructure part, connection part and coupling part form a unit.

For the features of the coupling part 740 of FIG. 17, the same reference signs are used as for the previous embodiment, with only differences being discussed.

In the embodiment shown in FIG. 17, the guide element 792 forms a continuous ring from which the plurality of snap-in lugs 790, in this case four snap-in lugs, protrude. Furthermore, the implant connection geometry is configured differently, with the contact portion of the coupling part 760 being frustoconical and the contact portion 766 being cylindrical.

In contrast to the previous embodiment, the geometry of the abutment connection for connecting the coupling part to the abutment in the embodiment shown in FIG. 17 is not rotationally symmetrical.

The guide element has an indexing section 714 in the form of a first and a second flattening of the radially outer wall surface 700 of the guide element. The first and second flattened portions extend in a first and second plane, respectively, running parallel to the longitudinal axis A of the coupling part, the first and second planes being perpendicular to one another in the present case. The wall surface of the receiving opening 704 of the abutment 730, which is not shown, has a structure complementary to the indexing section, which interact in the assembled state. The indexing section 714 is intended to allow a single position of the abutment 730 relative to the coupling part 760 in the assembled state and to form an anti-rotation lock between the abutment relative to the coupling part.

Four snap-in elements 738 extend in a coronal direction from the guide element 792. The snap-in elements 738 comprise a latch hook 795 with a lever arm 797 and an inwardly directed snap-in lug 790.

Further points on disclosure are listed below.
I. A coupling part for connection to a base, comprising an implant connecting geometry for connecting the coupling part to the base, an elongated hole which extends along a longitudinal axis of the coupling part from a coronal end to an apical end of the coupling part and is intended to receive a connection part having a head piece, and an abutment connecting geometry arranged at the coronal end of the coupling part for receiving a prosthetic abutment, characterized in that a connection part having a head piece, and an abutment connecting geometry arranged at the coronal end of the coupling part for receiving a prosthetic abutment, characterized in that the coupling part has an axially protruding guide element arranged at the coronal end of the coupling part and adjoining the elongated hole of the coupling part, which is arranged radially inwards with respect to the abutment connecting geometry and has a radially outer wall surface, and comprises at least one snap-in lug extending coronally from the guide element obliquely to the longitudinal axis of the coupling part in the direction of the elongated hole of the coupling part, which snap-in lug is intended for this purpose, engages in a counter-snap-in element of the connection part arranged apically to the head piece when, in an assembled state, the connection part is inserted into the elongated hole of the coupling part and into an elongated hole of the prosthetic abutment extending along the longitudinal axis of the coupling part and the head piece is supported against an abutment arranged in the elongated hole of the prosthetic abutment.
II. The coupling part according to point 1, characterized in that the guide element extends along the longitudinal axis of the coupling part in a prismatic or cylindrical shape.
III. The coupling part according to point 1 or 2, characterized in that the guide element has a radially inner wall surface which, viewed in the radial direction, is offset radially outwards towards the wall surface of the elongated hole of the coupling part.
IV. The coupling part according to one of points 1 to 3, characterized in that the guide element is intended to be inserted into an apically arranged receiving opening of the prosthetic abutment, the radially outer wall surface of the guide element being continuous or interrupted and being configured complementary to a wall surface of the receiving opening.
V. The coupling part according to point 4, characterized in that the guide element comprises an indexing portion intended to cooperate, in the assembled state, with a complementary structure of the prosthetic abutment in order to allow a single position of the prosthetic abutment relative to the coupling part.
VI. The coupling part according to point 5, characterized in that the indexing section is formed by at least one flattening of the radially outer wall surface of the guide element, which or wherein the flattening extends in a plane running parallel to the longitudinal axis of the coupling part.
VII. The coupling part according to point 4, characterized in that the radially outer wall surface of the guide element has a profile which, in the assembled state, is intended to interact with a further complementary structure of the prosthetic abutment in order to form an anti-rotation lock between the prosthetic abutment relative to the coupling part.
VIII. The coupling part according to one of points 1 to 7, characterized in that the end of the at least one snap-in lug facing the connection part has a curvature which is convex with respect to a longitudinal axis of the connection part and whose radius of curvature corresponds to the radius of the connection part.
IX. The coupling part according to one of points 1 to 8, characterized by a roundish groove which surrounds the guide element radially outwards and extends, viewed in the radial direction, from the radially outer wall surface of the guide element to the abutment connecting geometry of the coupling part.
X. The coupling part according to one of points 1 to 9, characterized in that the abutment connecting geometry is formed by a support surface which preferably extends in a plane perpendicular to the longitudinal axis of the coupling part.
XI. The coupling part according to one of points 1 to 10, characterized by a plurality of snap-in lugs which are preferably equally spaced apart in the circumferential direction.
XII. The coupling part according to one of points 1 to 11, characterized in that the guide element is continuous.
XIII. The coupling part according to one of points 1 to 11, characterized in that the guide element is interrupted by a plurality of guide segments, which are preferably equally spaced apart from one another in the circumferential direction and are of identical design, and comprises a plurality of snap-in lugs, preferably with one snap-in lug projecting from each guide segment.
XIV. An assembly comprising a coupling part according to one of the preceding points for connection to a dental base, an abutment for connection to the coupling part, and a connection part for fastening the abutment and the coupling part to the base, characterized in that the connection part has a counter-snap-in element which is arranged apically to the head piece thereof and is intended to receive the at least one snap-in lug, if appropriate the prosthetic abutment has an elongated hole for receiving the connection part, which or wherein the elongated hole has an abutment for receiving the head piece of the connection part, wherein in the assembled state the connection part is inserted into the elongated hole of the prosthetic abutment and into the elongated hole of the coupling part, the head piece is supported against the abutment and the at least one snap-in lug is engaged in the counter-snap-in element.
XV. The assembly according to item 14, characterized in that the connection part has a circumferential thickening which apically limits the counter-snap-in element.
XVI. Assembly according to one of the points 14 to 15, characterized in that the counter-engagement element has an axial length which permits an axial movement of the engaged snap-in lug towards the connection part, the axial movement being smaller than the axial height of the guide element, measured from the coronal end of the coupling part.
XVII. Assembly according to one of points 14 to 16, characterized in that the abutment has an apically arranged receiving opening for receiving the guide element and the at least one snap-in lug, which or wherein the receiving opening has a wall surface formed complementary to the radially outer wall surface of the guide element.
XVIII. The assembly according to point 17, characterized in that a surface of the abutment and the wall surface of the receiving opening of the prosthetic abutment, viewed in longitudinal section, are free of curvatures which have a radius of less than 0.3 mm.
XIX. The assembly according to any one of points 14 to 18, characterized in that the prosthetic abutment has a complementary structure which is intended to interact, in the assembled state, with an indexing portion of the coupling part.
XX. The assembly according to point 19, characterized in that the complementary structure comprises at least one flattening which extends in a plane parallel to the longitudinal axis of the coupling part and is intended to cooperate with at least one flattening of the radially outer wall surface of the guide element forming the indexing portion.
XXI. The assembly according to any one of points 14 to 20, characterized in that the prosthetic abutment member has a further complementary structure which, when assembled, is intended to cooperate with the profile of the radially outer wall surface of the guide member to form an anti-rotation lock between the prosthetic abutment member relative to the coupling member.
XXII. The assembly according to any one of points 14 to 21 comprising the dental base.

The present invention is not limited in its scope to the specific embodiments described herein. Rather, in addition to the examples disclosed herein, various further modifications of the present invention, which also fall within the scope of protection of the claims, will be apparent to those skilled in the art from the description and the accompanying figures. In addition, various references are cited in the description, the disclosure of which is hereby incorporated by reference into the description in its entirety.

### LIST OF REFERENCE SYMBOLS

1 Dental implant
10 Longitudinal axis
11 Assembly
2 Basic
21 Cutting thread
22 External thread
23 Internal thread
24 Bore, blind hole
25 Conical receptacle
26 Support section
26a Support section
27 Conical support
28 Anti-rotation section
29 Coronal sealing surface
3 Coupling part
30 Main body
301 Apical longitudinal end
302 Coronal longitudinal end
303 Rotary undercut
304 Transition section
31 Elongated hole
311 Support section
32 Coronal sealing surface
33 Support section
34 Contact portion
341 Flat contact surface
342 Straight-conical lateral surface
343 Curved-conical lateral surface
344 Inverted-conical lateral surface
35, 35′, 35″ Guide element
351 Surface area of the guide elements
35a Guide element
36 Anti-rotation section
37 Contact portion
38, 38′, 38″, 38′″ Snap-in element
38a, 38a′ Further snap-in element
380 Latch hook
381 Snap-in lug
382 Spring-elastic lever arm
39 Apical sealing surface
4 Abutment
401 Apical longitudinal end
402 Coronal longitudinal end
41 Apical sealing surface
42 Elongated hole
43 Conical support surface
44 First receptacle
45 Second receptacle
46 Further counter-snap-in element
461 Further snap-in groove
47 Guide element
48 Annular bead
5 Connection part
51 Engagement means
52 Head piece
53 Support section
54 Apical thread section
55 Apical end
56 Counter snap-in element
561 Snap-in groove
562 Ramp
57 Shaft
58 Guide section
59 Conical contact portion
6 Superstructure
61a Dental prosthesis, crown
61b Gingiva former, healing element
62 Elongated hole
810 Assembly, set
720 Base, dental implant body
730 Assembly, prosthetic abutment
732 Connection part, retaining screw
738 Snap-in element
740 Coupling part, adapter
742 Blind hole
744 Conical receptacle, coronal end of the implant
746 Internal thread of the blind hole
748 Apical thread section, external thread of retaining screw
750 Body of the adapter
754 Elongated hole, through hole of the adapter
756 Coronal end of the adapter
758 Apical end of the adapter
760 Contact portion, apical section of the adapter
762 Transition section, coronal section of the adapter
764 Coronal sealing surface, contact surface
766 Support section
770 Elongated hole, through hole of the abutment
772 Conical support surface, counter bearing in through hole of abutment
774 Head piece, head area of the retaining screw
776 Apical longitudinal end, front face of the abutment
780 Shank, bolt
782 Engagement means, recess for a hexagon wrench
790 Snap-in lugs
792 Guide element, carrier element
793 Guide segment, carrier segment
794 Rotary undercut, groove
795 Latch hook
796 Radial inner wall surface of the carrier element
797 Lever arm
798 Wall surface of the adapter through hole
700 Radial outer wall surface of the support element
702 Two receptacles, receptacle opening of the prosthetic abutment
704 Wall surface of the receptacle opening
710 Counter-snap-in element, snap-in recess
712 Guide section, thickening
714 Indexation section

1. A coupling part for connecting a base of a dental implant to an abutment of the dental implant, comprising
a main body,
an elongated hole along a longitudinal axis of the main body,
at least one snap-in element which is suitable for engaging in a snap-in operational connection with at least one counter-snap-in element of a connection part arranged in the elongated hole, and
a contact portion for sealingly contacting the coupling part with the base.

2. The coupling part according to claim 1, wherein the contact portion on the main body of the coupling part is configured as a flat surface perpendicular to the longitudinal axis of the main body or as a lateral surface of a straight truncated cone aligned with the longitudinal axis or as a lateral surface of a curved truncated cone aligned with the longitudinal axis or as a lateral surface of a conical depression in the main body aligned with the longitudinal axis.

3. The coupling part according to claim 1, wherein the at least one snap-in element is configured as an elastic snap-in element.

4. The coupling part according to claim 1, wherein at least one snap-in element is provided at a coronal longitudinal end and/or at an apical longitudinal end of the main body.

5. The coupling part according to claim 1, wherein the at least one snap-in element is configured as a latch hook formed on the main body parallel to the longitudinal axis.

6. The coupling part according to claim 1, wherein at least one guide element is provided at a coronal longitudinal end of the main body which is suitable for aligning the coupling part with respect to an abutment of a dental implant in alignment with the longitudinal axis.

7. The coupling part according to claim 1, wherein a rotary undercut is formed at the coronal longitudinal end of the coupling part in the region of the guide element.

8. The coupling part according to claim 1, wherein the surfaces of the coupling part in the contact portion have G1 continuity, and advantageously G2 continuity.

9. The coupling part according to claim 1, wherein the coupling part comprises a coronal sealing surface for tightly supporting the superstructure part on the coupling part.

10. The coupling part according to claim 9, wherein the coronal sealing surface is provided at a coronal longitudinal end of the main body and is configured as a flat, annular surface perpendicular to the longitudinal axis of the main body.

11. The coupling part according to claim 9, wherein the coronal sealing surface is arranged on the outer circumference of the contact portion between the body and the coupling part.

12. The coupling part according to claim 1, wherein an anti-rotation section is provided at a coronal longitudinal end and/or at an apical longitudinal end of the main body.

13. The coupling part according to claim 1, wherein the anti-rotation section has a non-rotationally symmetrical outer contour.

14. An assembly for a modular dental implant with an abutment,
a connection part for positively connecting the abutment to a base intended for implantation in the bone tissue of a patient, and
a coupling part according to claim 1,
wherein the abutment, the connection part and the coupling part are aligned along a common longitudinal axis,
wherein the connection part can be arranged in an elongated hole of the coupling part and an elongated hole of the abutment and
wherein the coupling part, the connection part and the abutment can be connected or are connected to one another in a form-fitting manner.

15. The assembly according to claim 14, wherein the connection part has at least one counter-snap-in element which is or can be brought into operational connection with at least one snap-in element of the coupling part.

16. The assembly according to claim 14, wherein the connection part can be reversibly connected to the coupling part.

17. A modular dental implant comprising a base for implantation in a bone tissue of a patient and an assembly according to claim 14.

18. The modular dental implant according to claim 17, wherein the apical sealing surface of the abutment rests on the coronal sealing surface of the coupling part in the assembled state, so that the dental implant is sealed at this contact point of the two components.

19. The modular dental implant according to claim 17, wherein the apical sealing surface of the coupling part in the assembled state rests on the coronal sealing surface of the base, so that the dental implant is sealed at this contact point of the two components.

20. A kit for constructing an assembly comprising at least one abutment, at least one connection part and at least one coupling part, as defined in an assembly according to claim 14.

21. A kit for constructing a modular dental implant comprising at least one base, at least one abutment, at least one connection part, and at least one coupling part, as defined in a dental implant according to claim 17.
